(19) United States
(12) Patent Application Publication
(10) Pub. No.: US 2025/0275546 A1
(43) Pub. Date: Sep. 4, 2025

(54) SYSTEM AND METHOD OF THAWING AND/OR COOKING FROZEN FOOD WITH NARROWBAND PHOTONIC IRRADIATION

(71) Applicant: PTI IP LLC, Cleveland, OH (US)

(72) Inventors: Don W. COCHRAN, Gates Mills, OH (US); Mark F. FLEMING, Strongsville, OH (US)

(73) Assignee: PTI IP LLC, Cleveland, OH (US)

(21) Appl. No.: 18/593,056

(22) Filed: Mar. 1, 2024

(51) Int. Cl. A23L 3/365; A23L 5/30

(52) U.S. Cl. CPC A23B 2/82; A23L 5/36

(57) ABSTRACT

A system and method for thawing and/or cooking various frozen foods is provided. The system and method implement narrowband energy to execute the thawing and/or cooking process more efficiently and effectively than could be achieved in heretofore conventional techniques. In at least one form, this includes obtaining information in the thawing process that is used as feedback and control for an improved subsequent process, e.g., a cooking process.

### BACKGROUND

Throughout history, cooking or heating of foodstuff has generally occurred in one of two conventional ways.

The first conventional example of how foodstuff has been heated uses conventional broadband techniques. A chemical reaction generated heat source such as an open flame, a resistive electric element, such as a calrod, or a broadband light source such as a heat lamp, quartz lamp, or lightbulb is used to generate broadband heat waves of various intensity within the visible and infrared light spectrum range. Some cooking implementations extend into the ultra-violet range as well. In use since antiquity, this example of heating foodstuffs has also been achieved in a tool called an oven. It is a hollow chamber used to expose material to a hot environment generated by one of a plethora of the broadband heat sources noted above in a controlled way.

The second conventional technique uses radio frequency generating devices, such as magnetrons, in microwave ovens to generate a standing wave inside of a device that excites polar molecules inside of the foodstuff such as water and fats. The molecules are excited by the radio frequency, generate heat, and in turn heat the foodstuff.

Another more recent technique combines these two conventional techniques, using high frequency waves, such as microwaves, in combination with resistive heating elements, quartz lamps, steam, or short pulses in the 10 MHz to 100 GHz range to thaw frozen food.

Such conventional heating techniques, however, have many drawbacks and inefficiencies. For example, thawing frozen food is not efficiently and effectively addressed by these conventional techniques. Furthermore, it can be desirable to thaw frozen food and hold the food in a refrigerated state until it is ready to be cooked. Using these conventional heating techniques would add undue heat to the refrigeration area if applied while the food target was in the refrigeration area. In turn, this added heat could raise temperature of other food stuffs to an undesired temperature range. Also, when using microwaves to heat, the water escaping in the form of steam can change the outer profile of the food making it undesirable, and microwaves excite the water within the food drying it out substantially.

Given these limitations of conventional cooking using a chamber to heat the air or atmosphere which in turn heats the outer layer of the target, and the limitations of microwaves to heat frozen water, it is desirable to defrost foods before cooking. Not doing so leads to uneven thermal profiles throughout the food and undesirable consequences to the outer edges of the food.

Aside from the process of thawing, food preparation in general can be time consuming, inconvenient, and requires skill to produce consistently satisfactory results. Satisfactory results are based on ingredient choice, ingredient combination schemes, and proper heat applied in the proper amounts and at the proper time to achieve expected results. Further complicating the matter, as noted above, is current heating methods either use broadband heating mechanisms to generate heat within a chamber or use radio frequencies or RF, commonly called microwaves, to excite polar molecules within the food. Current broadband heating mechanisms typically comprise flames, electric resistance, or broadband light sources that generate heat energy several thousand nanometers across the infrared electromagnetic spectrum and usually a portion of the visible spectrum as well.

More specifically, broadband sources of heat comprise chemical reactions that result in heat and flames such as the burning of wood, gas, charcoal, etc., or electric resistance devices such as resistance heating coils (more commonly called Calrods), lamps, tubes, and bulbs. In each of these methods, energy is typically generated in the visible light range and extends past the mid-IR range. This energy is transferred into a vessel, such as a pot or pan, using radiative and convective methods, or is transferred to the food using convection. In each of these instances, the majority heating of the food object starts at the near surface, transmits through a boundary layer between the food object and the heated air and slowly penetrates into the food at a rate based on the thermal transfer properties of the food. The consequence of heating this way is that the outside of the food is exposed to elevated temperatures for the duration of the cooking process. The result is loss of water, which in turn results in loss in flavor, nutrients, and can result in burning or charring. Burning and charring can produce undesirable and bitter flavors as well as potential carcinogens.

Radio frequency heating, also known as RF or microwave cooking, utilizes a different mechanism to heat than the various broadband sources. Microwaves create heat by exciting dipole molecules through resonance within the generated electric field. In RF heating, the electric field expands, peaks and contracts at a set wavelength in the microwave frequency range. At these wavelengths, dipole molecules, such as water, resonate with the electric field and begin to rotate. The rotational energy is converted to heat due to the water molecule not being able to complete a full rotation before the electric field collapses and reverses, forcing the water molecule to reverse its rotational momentum. Another mechanism of heating comes from the electric field imparting work on hydrogen atoms in the molecule. This interaction results in a higher vibration state and, therefore, increased temperature. To a much smaller effect, some heat is also achieved in thawed food by exciting ionic molecules with the corresponding, oscillating, magnetic field. The least heating effect comes from the photon energy at this wavelength. The kinetic energy generated by the interaction of the water molecules with the electric field is approximately 2500 times greater than the photonic energy imparted.

Both modes of energy impart undesirable characteristics to the food and increase variability that can negatively impact results. In the case of RF, or microwave heating, the very large wavelengths associated with microwaves cause large standing waves inside the heating chamber, causing hot and cold spots in the food target due to the size of the wave and due to constructive and destructive interference of the waves within the chamber. Household microwave ovens typically operate at a frequency of 2.45 GHz. Unlike what most people would expect, given the name it carries, this frequency corresponds with a wavelength of about 4.8 inches (12.3 cm) long. In addition, the method by which microwaves heat, spinning dipole molecules and vibrating the associated hydrogen atoms, targets water as the main heating mechanism. By overly exciting water to cause heat, a disproportionate amount of water is heated and is driven out of the food by the mechanism of evaporation at the surface and capillary action within the food stuff. Not only does this loss of water create undesirable textures in the comestible, the exiting water also removes water soluble molecules subtracting from the inherent flavor and nutritional value of the food.

In the case of broadband infrared heating, these devices produce energy across a very wide infrared spectrum. Some of these wavelengths cause heating of the food target. Some of these waves pass through the target, some are scattered and never enter the food, while others cause the target to brown or burn on or near its surface. As different substances absorb light radiation at different rates and convert it to heat, broadband irradiating of food stuffs, as done today, further adds variability to the cooking process. In addition, a large portion of these waves cause water to heat and much like the case of using microwaves, the water is driven off by the heat, leaving textural holes and driving flavor molecules away from the food with the evaporating water.

In both instances, the exact amount of energy performing work on the comestible target in the form of heat generation is difficult to determine as both heating methods do not impart energy evenly nor are they part of a closed loop system. In broadband heating, energy is lost to the surroundings at an unknown rate through conductive, convective, and radiant heat loss. During microwave heating, standing waves, as well as constructive and destructive wave interference, make knowing exact energy absorption in a given spot unknown. Given the limitations in these heating methods, exact cooking parameters needed to produce consistent results, such as time and intensity, cannot be fully known. This inability to fully control heat can have a major negative impact on final food quality as well as the food's nutritional value. Food quality is defined as a subjective evaluation of texture, flavor, and general mouthfeel (sensation in the mouth determined by such factors as moisture, richness, fattiness, astringency, and temperature).

### SUMMARY

In one aspect of the presently described embodiments, a system to thaw and cook a food item that is at least partially frozen comprises arrays of narrowband semiconductor irradiation devices configured to emit energy in a narrow wavelength band suitable for implementing a thawing process and a cooking process for the food item, at least one sensor positioned in the system to detect or measure physical properties of the food item, the system, or environment during the thawing process, and at least one processor and at least one memory having stored thereon code or instructions that, when executed by the processor, cause the system to collect information from the sensors on the detected or measured physical properties, and generate a cooking recipe based on at least the collected sensor information to be implemented in the cooking process.

In another aspect of the presently described embodiments, the at least one sensor is a temperature sensor.

In another aspect of the presently described embodiments, the at least one sensor is a temperature probe to be inserted in the food item.

In another aspect of the presently described embodiments, the at least one sensor is an infrared sensor.

In another aspect of the presently described embodiments, the at least one sensor is an infrared camera.

In another aspect of the presently described embodiments, the at least one sensor is a camera.

In another aspect of the presently described embodiments, the system comprises an oven.

In another aspect of the presently described embodiments, a method to accelerate thawing a food item that is at least partially frozen and located within a refrigerated area operative to hold the food item at a set temperature comprises emitting energy in a narrow wavelength band by arrays of narrowband semiconductor irradiation devices, the narrow wavelength band of energy being suitable for implementing a thawing process for the food item while minimizing heating of the surrounding area, detecting or measuring physical properties of the food item, a system in which the food item is positioned, or an environment around the food item during the thawing process, collecting information from the sensors on the detected or measured physical properties, and activating specific irradiation intensities or durations of activation based on at least the collected sensor information to be implemented in the accelerated thawing process.

In another aspect of the presently described embodiments, a method to thaw and cook a food item that is at least partially frozen comprises emitting energy in a narrow wavelength band by arrays of narrowband semiconductor irradiation devices, the narrow wavelength band of energy being suitable for implementing a thawing process and a cooking process for the food item, detecting or measuring physical properties of the food item, a system in which the food item is positioned, or an environment around the food item during the thawing process, collecting information from the sensors on the detected or measured physical properties, and generating a cooking recipe based on at least the collected sensor information to be implemented in the cooking process.

In another aspect of the presently described embodiments, the detecting or measuring is implemented using at least one sensor.

In another aspect of the presently described embodiments, the at least one sensor is a temperature sensor.

In another aspect of the presently described embodiments, the at least one sensor is a temperature probe to be inserted in the food item.

In another aspect of the presently described embodiments, the at least one sensor is an infrared sensor.

In another aspect of the presently described embodiments, the at least one sensor is an infrared camera.

In another aspect of the presently described embodiments, the at least one sensor is a camera.

In another aspect of the presently described embodiments, the at least one sensor is positioned in an oven.

In another aspect of the presently described embodiments, a method to thaw and/or heat a food item that is at least partially frozen comprises positioning or detecting the food item in an irradiation area configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, detecting, by at least one sensor positioned in the irradiation area and operatively connected to a control system, at least one physical property of at least one of the food item, the irradiation area or an environment during a heating process, translating the detected physical property into at least one measurement and executing cooking instructions utilizing instructions to bring the food item to a desired state and temperature in accordance with at least one of: the at least one physical property detected by the at least one sensor positioned in the system or the at least one measurement, wherein the executing includes at least-producing, by the at least one array of NREDs, at least 5 Watts per square inch of narrowband infrared energy at a target plane of the food item when the target is in its at least partially frozen state, wherein the irradiation area is supplied with the at least 5 Watts per square inch of infrared narrowband energy to each of at least 12 square inches of the target plane, and producing, by the at least one array of NREDs, at least 6 Watts per square inch of infrared energy at the target plane when the target is in a thawed state, wherein the irradiation area is supplied with the at least 6 Watts per square inch of infrared narrowband energy to the each of the at least 12 square inches of the target plane, and wherein the method further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, bringing the food item to a desired state and temperature comprises bringing the food item to a temperature above freezing.

In another aspect of the presently described embodiments, bringing the food item to a desired state and temperature comprises applying energy to affect at least one of defrosting the food item and temperature rise of the food item.

In another aspect of the presently described embodiments, the at least one sensor is a temperature sensor.

In another aspect of the presently described embodiments, the at least one sensor is a temperature probe to be inserted in the food item.

In another aspect of the presently described embodiments, the at least one sensor is an infrared sensor, calibrated to monitor temperature.

In another aspect of the presently described embodiments, the at least one sensor is an infrared camera.

In another aspect of the presently described embodiments, the at least one sensor is a digital, visible light, camera.

In another aspect of the presently described embodiments, the at least one sensor is used to detect weight of the food item.

In another aspect of the presently described embodiments, the at least one sensor is used to detect air-born chemicals.

In another aspect of the presently described embodiments, the irradiation area comprises an oven.

In another aspect of the presently described embodiments, the instructions comprise stored code.

In another aspect of the presently described embodiments, the cooking instructions are executed utilizing information from at least one of machine learning algorithms or artificial intelligence.

In another aspect of the presently described embodiments, the method further comprises accelerating thawing the food item within a refrigerated area and holding the food item at a maximum temperature of 5° F. above that of the refrigerated area,
wherein accelerated thawing is achieved through moving the food item having at least some frozen component into an enclosed irradiation area wherein the atmosphere in the enclosed irradiation area is conditioned to maintain at least a specific range of temperatures, wherein the at least one NREDs are configured to irradiate the food target with at least 5 Watts per square inch of narrowband infrared energy at a target plane of the food item during any portion of the thawing process, monitoring the food item and a rate of change in temperature of the food item as the food item is being irradiated using narrowband infrared radiation, based on data collected during the irradiation of the food item in at least one of a frozen and thawed state, adjusting at least one of radiation intensity and duration to bring the food item to the desired state and temperature in accordance with the at least one sensor positioned in the system.

In another aspect of the presently described embodiments, the detecting, translating and executing comprises monitoring the food item and a rate of change in temperature of the food item as the food item is being irradiated using narrowband infrared radiation, processing temperature data based on expected heat transfer parameters of various food items, determining a state of the food item by analyzing temperature rise of the food item when exposed to at least one of known irradiation intensity or variation in irradiation intensity, analyzing at least one of sensor output, time, and operator observations while executing a first set of cooking instructions for applying heat energy to the food item in a frozen state until the food item reaches a thawed state, executing a separate set of cooking instructions once the food item reaches an expected thawed state, after being confirmed by sensor data that the food has achieved a thawed state, and based on data collected during irradiation of the food item in at least one of a frozen and a thawed state, adjusting the cooking instructions to bring the food item to the desired state and temperature in accordance with the at least one sensor positioned in the system.

In another aspect of the presently described embodiments, the method further comprises monitoring a weight of the food item in an at least one point of time, wherein a point in time is one of before or during irradiation of the food item using narrowband infrared radiation, processing the weight data based on expected heat transfer parameters of various food items, analyzing the weight data based on temperature rise and joules of energy injected to calculate a projected temperature rise and, if actual temperature rise varies from projected temperature rise, executing an adjustment to bring the food item to the desired state and temperature in accordance with the at least one sensor positioned in the system.

In another aspect of the presently described embodiments, the 12 square inches of target plane are 12 contiguous square inches.

In another aspect of the presently described embodiments, a method for heating a food item to maximize at least one of flavor retention, nutrient retention, moisture retention, and any combination of the three, comprises positioning or detecting the food item in an irradiation area configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, detecting, by at least one sensor positioned in the irradiation area and operatively connected to a control system, at least one physical property of at least one of the food item, the irradiation area or an environment during a heating process, translating the detected physical property into at least one measurement and executing cooking instructions utilizing stored instructions to maintain a majority of the food item below a boiling point of water (212° F. (100° C.) at 1 atmosphere of pressure) when cooking comestibles low in Actin protein and below 155° F. (68° C.) when cooking food items high in Actin protein for the duration of the irradiation of the food item in accordance with at least one of: the detecting or the translating,
wherein the executing includes at least-producing, by the at least one array of NREDs, at least 6 Watts per square inch of infrared energy at the target plane when the target is in a thawed state, wherein the irradiation area is supplied the at least 6 Watts per square inch of infrared narrowband energy to each of at least 12 square inches of a target plane, and wherein the method comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the at least one sensor is a temperature sensor.

In another aspect of the presently described embodiments, the at least one sensor is a temperature probe to be inserted in the food item.

In another aspect of the presently described embodiments, the at least one sensor is an infrared sensor, calibrated to monitor temperature.

In another aspect of the presently described embodiments, the at least one sensor is an infrared camera.

In another aspect of the presently described embodiments, the at least one sensor is a digital, visible light, camera.

In another aspect of the presently described embodiments, the at least one sensor is used to detect the weight of the comestible or target.

In another aspect of the presently described embodiments, the irradiation area comprises an oven.

In another aspect of the presently described embodiments, the method further comprises detecting air-born chemical samples at least one time in an atmosphere of the irradiation area, processing the air-born chemical sample based on at least one expected physical property of at least one chemical, translating at least one detected physical property of the chemical into measurement values of chemical concentration within the sampled atmosphere, comparing the measurement values to an at least one desired stored value to maintain temperature of the food item below a temperature at which the chemical affecting smell would be released in sufficient quantities to exceed desired values within the irradiation area based on current atmospheric conditions in the irradiation area.

In another aspect of the presently described embodiments, the processing of the air-born chemical sample is based on information from at least one of machine learning algorithms and artificial intelligence.

In another aspect of the presently described embodiments, the air-born chemical sample detected is trimethylamine.

In another aspect of the presently described embodiments, the NREDs having a FWHM wavelength spectrum width of less than 80 nm and an output peak wavelength in the 720 nm to 1180 nm range can be further paired with at least one NRED having a FWHM wavelength spectrum width of less than 80 nm and an output peak wavelength in a range of 1380 nanometers to 1580 nanometers.

In another aspect of the presently described embodiments, NREDs having a FWHM wavelength spectrum of less than 80 nm and an output peak wavelength in the 720 nm to 1180 nm range can be further paired with any other broadband heat source.

In another aspect of the presently described embodiments, the broadband heat source comprises at least one of quartz lamps, halogen lamps, heating from chemical reactions such as oxidizing combustibles to create flames, or resistive heating elements.

In another aspect of the presently described embodiments, the 12 square inches of target plane are 12 contiguous square inches.

In another aspect of the presently described embodiments, a method for heating the surface of food items to maximize flavor, nutrient, and moisture retention, comprises positioning or detecting the food item in an irradiation area configured for irradiation of the food item by at least one array of narrowband infrared radiation emitting devices (NREDs), wherein the food item has at least five (5) times the absorptive units at a selected peak wavelength within a range of 1380 nm to 1580 nm range as water would have if irradiated using narrowband infrared radiation within a range of 720 nm to 1180 nm range, wherein the NREDs are operative having a Full Width at Half Maximum (FWHM) wavelength spectrum width of less than 80 nanometers (nm) and an output peak wavelength in the 1380 nm to 1580 nm range, to effect at least one of defrosting, heating, and cooking, detecting, by at least one sensor positioned in the irradiation area and operatively connected to a control system, at least one physical property of at least one of the food item, the irradiation area or an environment during a heating process, translating the detected physical property into at least one measurement and executing cooking instructions utilizing instructions to increase surface temperature of the food item to a temperature in a range of 230° F. (110° C.) to 397° F. (203° C.) while heat generated from application of the narrowband wavelength operative in the range of 1380 nm to 1580 nm does not affect a heat rise in a majority of the food item by more than 4° F. (2° C.) while under irradiation from the at least one array of NREDs operative in the range of 1380 nm to 1580 nm, in accordance with at least one of: the detecting or the translating, wherein the executing includes at least-producing, by the at least one array of NREDs, at least 4 Watts per square inch of infrared energy at the target plane when the target is in a thawed state, wherein the irradiation area is supplied the at least 4 Watts per square inch of infrared narrowband energy to each of at least 12 square inches of a target plane, and wherein the method further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, cooking instructions are executed utilizing information from at least one of machine learning algorithms and artificial intelligence.

In another aspect of the presently described embodiments, the at least one sensor is a temperature sensor.

In another aspect of the presently described embodiments, the at least one sensor is a temperature probe to be inserted in the food item.

In another aspect of the presently described embodiments, the at least one sensor is an infrared sensor, calibrated to monitor temperature.

In another aspect of the presently described embodiments, the at least one sensor is an infrared camera.

In another aspect of the presently described embodiments, the at least one sensor is a digital, visible light, camera.

In another aspect of the presently described embodiments, the at least one sensor is used to detect the weight of the comestible or target.

In another aspect of the presently described embodiments, the at least one sensor is used to detect air-born chemicals.

In another aspect of the presently described embodiments, the method further comprises executing the cooking instructions to increase surface temperature of the comestible target to a temperature above 397° F. (203° C.) while heat generated from application of the narrowband wavelength operative in the 1380 nm to 1580 nm range does not affect a heat rise in a majority of the comestible target by more than 5° F. (2.8° C.) while under irradiation from the at least one array of NREDs operative in the 1380 nm to 1580 nm range.

In another aspect of the presently described embodiments, the method further comprises radio frequency elements or microwave elements to be selectively activated for defrosting, heating, cooking, boiling, or other form of treating the food item in addition to narrowband surface heating.

In another aspect of the presently described embodiments, the 12 square inches of target plane are 12 contiguous square inches.

In another aspect of the presently described embodiments, a method for thawing food items in a refrigerated environment, comprises detecting a food item in an irradiation area of a refrigeration unit configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, producing, by the at least one array of NREDs, at least 5 Watts per square inch of infrared energy at the target plane when the target is in a thawed state, wherein the irradiation area is supplied the at least 5 Watts per square inch of infrared narrowband energy to each of at least 12 square inches of a target plane, detecting, by at least one sensor positioned in the irradiation area and operatively connected to a control system, temperature of at least one of the food item, the irradiation area or an environment during a heating process, monitoring the food item and a rate of change in the temperature of the food item as the food item is being irradiated using narrowband infrared radiation and based on data collected during the irradiation of the food item in at least one of a frozen and thawed state, adjusting at least one of radiation intensity and duration of the producing to bring the food item to the desired state and temperature in accordance with the at least one sensor positioned in the system, wherein the food item is held at a maximum of 5° F. above that of the refrigeration unit, and wherein the method further comprises continuously controlling or limiting amperes of electrical current supplied to the at least one array of NREDs using a control system operatively connected to at least one Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the 12 square inches of target plane are 12 contiguous square inches.

In another aspect of the presently described embodiments, a system to thaw and cook a food item that is at least partially frozen, comprises at least one array of narrowband infrared radiation emitting devices (NREDs) configured to emit energy in a narrow wavelength band suitable for implementing a thawing process and a cooking process for the food item, at least one sensor positioned in the system to detect or measure physical properties of at least one of the food item, the system, or environment during the thawing process and at least one processor and at least one memory having stored thereon code or instructions that, when executed by the processor, cause the system at least to: position or detect the food item in an irradiation area configured for irradiation of the food item by the at least one array of NREDs, wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, detect, by the at least one sensor positioned in the irradiation area and operatively connected to the system, at least one physical property of at least one of the food item, the irradiation area or the environment during a heating process, translate the detected physical property into at least one measurement and execute cooking instructions utilizing stored instructions to bring the food item to a desired state and temperature in accordance with at least one of: the detecting or the translating, wherein executing includes at least-producing, by the at least one array of NREDs, at least 5 Watts per square inch of narrowband infrared energy at a target plane of the food item when the target is in its at least partially frozen state, wherein the irradiation area is supplied the at least 5 Watts per square inch of infrared narrowband energy to each of at least 12 contiguous square inches of the target plane, and producing, by the at least one array of NREDs, at least 6 Watts per square inch of infrared energy at the target plane when the target is in a thawed state, wherein the irradiation area is supplied the at least 6 Watts per square inch of infrared narrowband energy to the each of the at least 12 square inches of the target plane, wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the 12 square inches of target plane are 12 contiguous square inches.

In another aspect of the presently described embodiments, a system to thaw and cook a food item that is at least partially frozen, comprises at least one array of narrowband infrared radiation emitting devices (NREDs) configured to emit energy in a narrow wavelength band suitable for implementing a thawing process and a cooking process for the food item, at least one sensor positioned in the system to detect or measure physical properties of at least one of the food item, the system, or environment during the thawing process and at least one processor and at least one memory having stored thereon code or instructions that, when executed by the processor, cause the system at least to: position or detect the food item in an irradiation area configured for irradiation of the food item by the at least one array of NREDs, wherein the food item has at least three (3) times the absorptive units at a selected peak wavelength as water does at the same wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, detect, by the at least one sensor positioned in the irradiation area and operatively connected to the system, at least one physical property of at least one of the food item, the irradiation area or the environment during a heating process, translate the detected physical property into at least one measurement and execute cooking instructions utilizing stored instructions to maintain a majority of the food item below a boiling point of water (212° F. (100° C.) at 1 atmosphere of pressure) when cooking comestibles low in Actin protein and below 155° F. (68° C.) when cooking food items high in Actin protein for the duration of the irradiation of the food item in accordance with at least one of: the detecting or the translating, wherein executing includes at least-producing, by the at least one array of NREDs, at least 6 Watts per square inch of infrared energy at the target plane when the target is in a thawed state, wherein the irradiation area is supplied the at least 6 Watts per square inch of infrared narrowband energy to each of at least 12 square inches of a target plane, and wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the 12 square inches of target plane are 12 contiguous square inches.

In another aspect of the presently described embodiments, a system to thaw and cook a food item that is at least partially frozen, comprises at least one array of narrowband infrared radiation emitting devices (NREDs) configured to emit energy in a narrow wavelength band suitable for implementing a thawing process and a cooking process for the food item, at least one sensor positioned in the system to detect or measure physical properties of at least one of the food item, the system, or environment during the thawing process and at least one processor and at least one memory having stored thereon code or instructions that, when executed by the processor, cause the system at least to: position or detect the food item in an irradiation area configured for irradiation of the food item by the at least one array of NREDs, wherein the food item has at least five (5) times the absorptive units at a selected peak wavelength within a range of 1380 nm to 1580 nm range as associated water would have if irradiated using narrowband infrared radiation within a range of 720 nm to 1180 nm range, wherein the NREDs are operative having a Full Width at Half Maximum (FWHM) wavelength spectrum width of less than 80 nanometers (nm) and an output peak wavelength in the 1380 nm to 1580 nm range, to effect at least one of defrosting, heating, and cooking, detect, by the at least one sensor positioned in the irradiation area and operatively connected to the system, at least one physical property of at least one of the food item, the irradiation area or the environment during a heating process, translate the detected physical property into at least one measurement and execute cooking instructions utilizing stored instructions to increase surface temperature of the food item to a temperature in a range of 230° F. (110° C.) to 397° F. (203° C.) while heat generated from application of the narrowband wavelength operative in the range of 1380 nm to 1580 nm does not affect a heat rise in a majority of the food item by more than 4° F. (2° C.) while under irradiation from the at least one array of NREDs operative in the range of 1380 nm to 1580 nm, in accordance with at least one of: the detecting or the translating, wherein executing includes at least-producing, by the at least one array of NREDs, at least 4 Watts per square inch of infrared energy at the target plane when the target is in a thawed state, wherein the irradiation area is supplied the at least 4 Watts per square inch of infrared narrowband energy to each of at least 12 square inches of a target plane, and wherein the system is further caused to continuously control or limit amperes of electrical current supplied to the at least one array of NREDs using a control system operatively connected to at least one Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the 12 square inches of target plane are 12 contiguous square inches.

In another aspect of the presently described embodiments, a system to thaw a food item in a refrigerated environment, comprises at least one array of narrowband infrared radiation emitting devices (NREDs) configured to emit energy in a narrow wavelength band suitable for implementing a thawing process and a cooking process for the food item, at least one sensor positioned in the system to detect or measure physical properties of at least one of the food item, the system, or environment during the thawing process and at least one processor and at least one memory having stored thereon code or instructions that, when executed by the processor, cause the system at least to: detect a food item in an irradiation area of a refrigeration unit configured for irradiation of the food item by the at least one array of NREDs, wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking, produce, by the at least one array of NREDs, at least 5 Watts per square inch of infrared energy at the target plane when the target is in a thawed state, wherein the irradiation area is supplied the at least 5 Watts per square inch of infrared narrowband energy to each of at least 12 square inches of a target plane, detect, by the at least one sensor positioned in the irradiation area and operatively connected to the system, temperature of at least one of the food item, the irradiation area or an environment during a heating process, monitor the food item and a rate of change in the temperature of the food item as the food item is being irradiated using narrowband infrared radiation and based on data collected during the irradiation of the food item in at least one of a frozen and thawed state, adjust at least one of radiation intensity and duration of the producing to bring the food item to the desired state and temperature in accordance with the at least one sensor positioned in the system, wherein the food item is held at a maximum of 5° F. above that of the refrigeration unit, and wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs.

In another aspect of the presently described embodiments, the 12 square inches of target plane are 12 contiguous square inches.

### DRAWINGS

FIG. 1 illustrates heat and mass (moisture) transfer in a foodstuff;

FIG. 2 is a graph (i.e., mass transfer rate versus time) illustrating transitions from a thawed state to a cooked state;

FIG. 3 illustrates a comparison of thawing using microwave elements and thawing according to the presently described embodiments;

FIG. 4 illustrates is a graph illustrating state transitions;

FIG. 5 is a representative illustration of a narrowband oven incorporating the presently described embodiments;

FIG. 6 illustrates molecular activity;

FIG. 7 is a representative illustration of a narrowband unit incorporating the presently described embodiments;

FIG. 8 is a flowchart illustrating an example method according to the presently described embodiments;

FIG. 9 is a flowchart illustrating an example method according to the presently described embodiments;

FIG. 10 is a flowchart illustrating an example method according to the presently described embodiments; and,

FIG. 11 is a flowchart illustrating an example method according to the presently described embodiments.

### DETAILED DESCRIPTION

The presently described embodiments relate to a novel way of thawing or cooking various frozen foods using narrowband energy to execute the thawing and/or cooking process more efficiently and effectively than could be achieved in heretofore conventional techniques. In at least one form, this includes obtaining information in the thawing process that is used as feedback and control for an improved subsequent process, e.g., a cooking process. In at least one form, thawing is achieved for a frozen or partially frozen food item in a refrigerated environment and the food item is maintained in a thawed (e.g., not cooked) but refrigerated state.

As referenced above, drawbacks and inefficiencies exist in the conventional heating technology. In traditional ovens, when using broadband heating sources in an enclosed area, heat transfer from the heat source to the target is achieved through radiative heat and convective heat. Although radiative heat is present due to the heat generation source and reradiation from the graybody enclosure, the usable amount of radiative heat is diminished due to the broadband nature of the radiation and the nature of the graybody enclosure. Plainly stated, some of the radiation is absorbed by the target and the enclosure, some is reflected off either or both, and some passes through either or both with minimal absorption or heat transfer.

Broadband convective heating is also an inefficient method of heat transfer from the source to the target because air is actually an excellent thermal insulator. As such, it is a poor medium for heat transfer. In addition, the thermal and fluid flow boundary layer between the target and bulk air further slows the heat transfer. Boundary layers can be made smaller as the airflow around the target increases, but they can never be eliminated due to the nature of fluid flow and heat transfer principles.

In addition to the issue with boundary layers between the bulk air and the target, food has another specific issue in that it contains water that heats during the cooking process. It undergoes a phase change to vapor by absorbing heat from the heated bulk air. As such, the moisture level in the air directly affects the wet bulb temperature and, thus, the ability to transfer heat into the target or comestible item. In turn, this affects the consistency of the final product as humidity varies and is difficult to control.

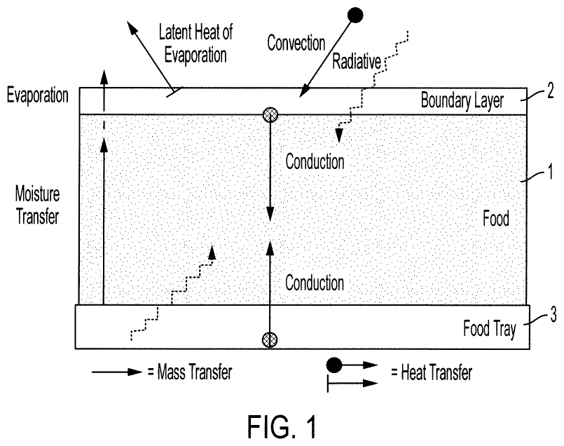

With reference to FIG. 1, all foodstuff that contains water, and is processed by convective heat transfer, has coupled heat and mass transfer affecting how the food is heated. In a conventional oven, the surrounding media is air. The air bulk is heated by the heat source and some radiative energy from the walls of the enclosure act as a graybody reflector or re-radiator. As shown, the hot air bulk then transfers heat to the boundary layer 2 of the food target 1 and ultimately into the food target 1 (shown set in a food tray 3). The heat transfer evaporates water on the surface, to superheat the vapor, and to heat the food target in accordance with the thermal properties of the food target. There are many thermal dynamics that take place during the heating and/or cooking process. As shown, various mass and heat transfers occur in these processes. As to mass transfers, for example, moisture is transferred from and through the food target 1. Evaporation occurs, resulting in heat transfer, e.g., latent heat of evaporation. Also, as mentioned, convective and radiative heat is transferred to impact the food target 1, and heat is transferred through the food target 1 via conduction.

For example, conduction is heat transfer by diffusion. Energy is distributed in a medium due to a temperature gradient within the medium. The physical mechanism is achieved through random atomic or molecular activity. Fourier's law captures the observed phenomena in the conduction rate equation:

$${q}_{n} = - k \frac{\partial T}{\partial n}$$

where qₙ is the heat flux in the normal direction, k is the thermal conductivity and Tis the temperature. The minus sign indicates that heat is always being transferred in the direction of decreasing temperature.

Thermal conductivity, k, is the transport property of the material that indicates the rate of energy that is transferred by the heat diffusion process. The conductivity of a solid is in general larger than that of a liquid, which is larger than that of a gas. The trend is due largely to differences in intermolecular spacing for the three phases.

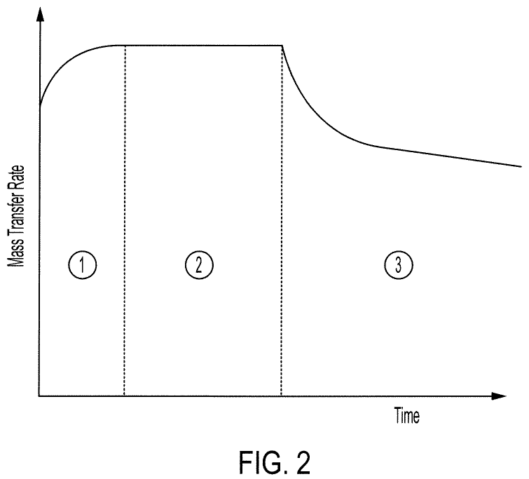

As shown in FIG. 2, heating in thawing environments is divided into three periods. FIG. 2 is a simple graph showing how a generic food item transitions from a thawed state to a cooked state. Period 1 is the preheat period in which surface temperature of the foodstuff is heated from the initial temperature to the wet-bulb temperature of the bulk air. During this period, the vapor will condense on the surface until the dew point temperature is achieved. During the preheat period, water will condense on the surface of the target. This phase can be greatly extended if the targeted food is frozen. In frozen food, the bulk air heat must be transferred into the solid surface, effecting a phase change from ice to water and then effecting a phase change from water to vapor. Further exacerbating the situation, is that heat transfer from air to solid ice is dramatically less efficient than the heat transfer rate of air to liquid.

With further reference to FIG. 2, period 2 is the constant-rate period. During this period, the surface temperature is that of the wet-bulb temperature of the bulk air. Water is evaporated from the surface and transported through the boundary layer to the surrounding air. Water is also transported from the interior and evaporated (See FIG. 1 above). During this period, the transport from the surface to the air is much slower than the transport inside the product. There is a decrease in mass transfer rate when the water reaches the surface. The surface temperature during this period is equal to the wet bulb temperature of the air. All heat is used to evaporate water from the surface of the product.

As shown in FIG. 2, period 3 occurs as the outer layer of the product has transitioned most of its water to vapor slowing water transport. In a sense, a dry shell has formed. As mass transfer of water decreases in Period 3, temperatures change faster as less heat is used for the phase change of water into vapor and penetrates the target more.

Moisture and humidity in the bulk air impacts cooking results because it affects the rate at which vapor from the food target is released into the bulk air, ultimately affecting heat transfer towards the core of the target. As such, to get consistent results when cooking with conventional broadband heating technology, humidity in the air must be controlled.

Another complication with cooking using conventional broadband heating technologies is that cooking a frozen product can dramatically change the heating profile. When heating a food substance from frozen to cooked in a conventional oven, initial heating is from the air to the outer frozen layer of the solid food. With enough heat, a phase change from solid to liquid occurs in the outer frozen layer of the food and mass transfer of water to the surface as well as evaporation begins. Because of inefficiencies in heat transfer between liquid to solid exist, the inner layer of the food does not thaw as quickly as the outer layer. As such, the outer layer is being depleted of its water and not replenished by mass transfer of water from the inner frozen layer. As such, the dry shell can be quite pronounced before the target has fully transitioned its water from solid to liquid phase. This phenomenon can lead to an overly cooked outer layer and an undercooked and even frozen inner layer when using conventional broadband cooking to cook from frozen.

As further example of the deficiencies of conventional techniques, microwaves are not proficient at thawing ice or frozen foods because the method by which it creates heat is ineffective in ice. Microwaves, or as called by another name, RF energy, are an oscillating electric field in the GHz frequency range used in heating applications to excite dipole molecules. At lower frequency electric fields, the dipole molecule orientations easily follow changes in the electric field. At the GHz frequency of a microwave oven, the inertia of molecules and their interactions with neighboring molecules make changing orientation more difficult and so the dipole molecules lag behind the field. The phase lag of the dipoles behind the electric field absorbs power from the field. This is known by those skilled in the art as dielectric loss due to dipole relaxation and equates to the microwave power absorbed by a dielectric. In simple terms, microwaves attempt to fully rotate dipole molecules. Due to the frequency of the microwave, the molecules can only partially rotate causing heat to be generated in the process as the partially rotating molecules try to align with the electric field.

Fundamentally, if water is frozen, the H2O molecules are locked up in a crystalline matrix and are not free to move or spin. Conversely, when water is in its liquid form, the molecules are free and fluid and can move, vibrate, and spin readily, thus creating heat. In practice, this means that when a chunk of ice, regardless of whether it has food in it or not, is placed in a field of microwave/radio frequency energy, it is ineffective at heating or melting the ice at a reasonable speed.

In addition, with radio frequency generated using magnetrons, heating is sporadic. Standing waves formed inside of the enclosed ovens generate constructive feedback in some areas of the enclosure and destructive feedback in other areas, leaving hot and cold spots in the target food. These hot and cold spots make it difficult to consistently apply heat to the food target. Some areas become overheated while others are underheated. In addition, the inconsistent heating makes it difficult to balance the energy input needed with the food target's heat transfer rate to predictably heat the center of larger food targets.

Another limitation of using microwaves to heat is that when water is frozen, it is in a crystalline structure. Radio frequency, an alternative name for microwaves, cannot rotate the water in ice since it is bound up in a crystalline structure. Food consists largely of water. For example, beef rump roast is about 73% water, a typical chicken fryer is about 66% water, a chicken breast is about 69% water, and salmon is about 70% water. When frozen, the efficacy of trying to consistently heat the food target is further exacerbated resulting in portions being overly hot and dried out while other areas remain cold or frozen.

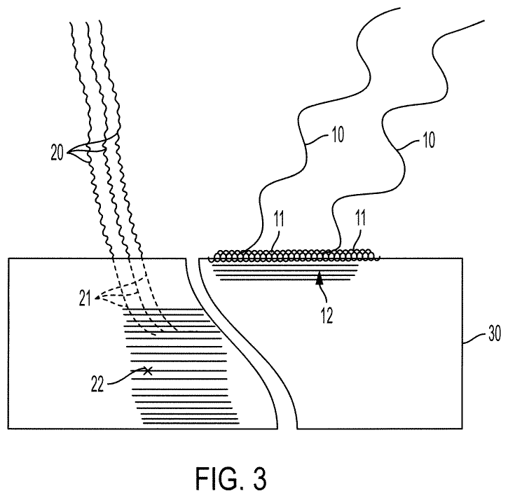

To fully understand the current limitations, consider a block of ice placed into a microwave oven or microwave/RF energy field. In FIG. 3, microwave energy (10) is directed toward an ice mass (30) (split for ease of explanation). To the extent that the ice block (30) is in an environment which is greater than 32 degrees, there will be, inevitably, some amount of melted water (11) on the surface of the ice. The microwaves (10) will interact with that melted, liquid water (11) and will resonate with the polar molecules of water and will cause them to gain energy through the sympathetic resonance thus causing rotation and vibration. This rotational energy creates some heat, which will with some time lapse, start to melt an additional amount of liquid water below it. The microwave or RF energy (10) which is not expended in the resonation process, will continue through the block of ice (30), because it cannot spin the water molecules that are locked up in the crystalline ice structure. Lacking liquid water, the only heat imparting capability that the microwaves or RF energy have is direct absorption of the RF energy by the ice. This “direct absorption” is at an extremely low level, about 4 to 6 orders of magnitude lower than the energy it would have imparted to liquid water (11). It is virtually useless as a heating modality in the direct absorption situation in which it must pass through only crystalline ice.

Crystalline ice is like a highly transparent window to the microwaves or RF energy. The slightly heated water (11) on the surface, now conductively imparts some heat in the region (12), immediately adjacent to the melted water. For all practical purposes, the only real heating that is taking place is in the melted water (11), which then conducts its heat into the near surface layers of the crystalline ice (30), at which location it starts to contribute to the latent heat of melting that is necessary to continue the process of melting.

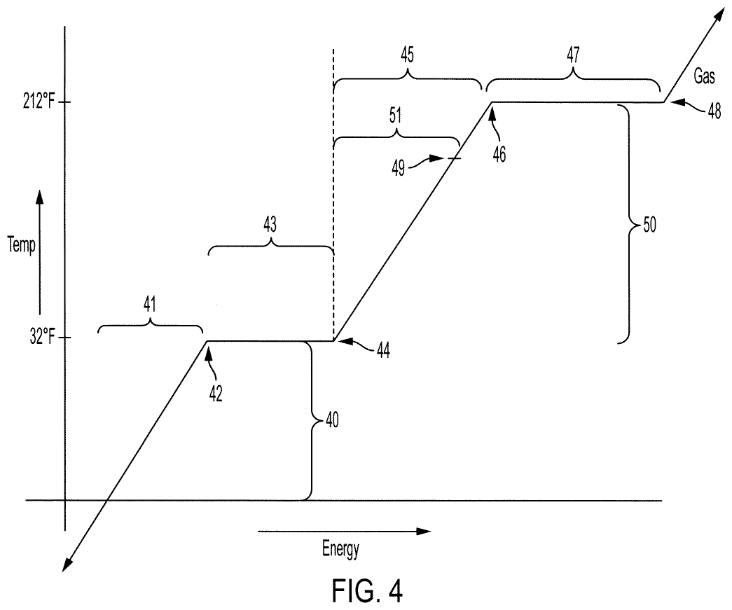

The latent heat of melting is a well-known phenomenon. It requires 333 joules per gram to convert ice at 32 degrees to water at 32 degrees F. With reference to FIG. 4, note the energy (43) which is needed to melt the frozen ice (42) into liquid water (44). It takes the same amount of heat energy (43) to convert ice at 32 degrees F. (42) to water at 32 degrees F. (44), as it does to raise the temperature of liquid water from 32 degrees F. (44) to 175 degrees F. (49) which energy amount is shown as (51).

A microwave oven or system must input all that heat of enthalpy, which is needed to melt the ice, from the outer extremities of the ice. That heat (12) must then “soak” by conduction through the balance of the thickness of the ice block (30). The speed of heat conduction in ice is about 2.22 to 2.35 watts per meter-Kelvin (w/mK). While that is approximately 4 times the 0.598 watts per meter-Kelvin of heat conduction of liquid water, it is very slow compared to the radio frequency or electromagnetic radiation speeds of the narrowband energy that is utilized in the presently described embodiments.

In U.S. Pat. No. 4,453,066, Fumiko teaches a method and an apparatus for thawing frozen food by high frequency heating. He also teaches the need to divide the thawing process into at least four stages of execution. Although in this patent the term high frequency is used often, it is not defined. High frequency relative to visible light would be ionizing wavelengths in which this patent clearly does not reference. High frequency relative to radio waves is more appropriate and in particular frequencies within the microwave range are most likely as he references the importance of monitoring the dielectric constants of the foodstuffs as well as his reference to, “The factors incorporated in the formulae of the five stages are experimentally obtained from business or domestic high frequency heating apparatus now widely used and are applicable to ready-frozen and home-frozen food stuff.” For reference, the imaginary component of dielectric constants starts having an effect at the approximate 300 GHz frequency (0.1 cm wavelength). Its effect peaks around 20 GHz. The dielectric constant component also starts at the approximate 300 GHz frequency peaking around 2 GHz and continues on into larger, lower frequency wavelengths.

Incorrectly taught in Fumiko's patent is that microwaves, referenced in the patent as, “high frequency electromagnetic waves” as established above, generate heat in the food stuff by increasing the enthalpy thereof from both the outer surface and also from the interior of the food since the food acts as a “heat generating element due to the electromagnetic energy absorption therein”. As noted above, in actuality, due to the dipoles in the food being locked up in a crystalline structure that the waves actually pass through with little impact. He then dismisses the resultant inferior results as being from the lack of careful consideration to the distribution of the microwaves. He does not teach, nor contemplate that microwaves cannot heat the frozen interior of the food due to the nature of how microwaves generate heat using dipole resonance.

Also incorrectly taught is that by having a short thaw time, a low final temperature, and the “maximum ice crystallization zone” is passed through quickly that food stuff can be thawed without drying or overheating the surface. Also incorrectly taught is that food stuff quality is a function of the time to defrost. This teaching incorrectly identifies the mechanism in which microwaves dry out food and degrade final quality. Microwaves primarily use the dipole nature of water to generate heat. If heat is generated faster than can be conductively transmitted to the center of the food target, heating will occur until the water reaches its evaporation temperature as dictated by the relative humidity in the microwave chamber. At that point, water loss is accelerated. If the food target is frozen, surface heating is exacerbated as the interior of the food target must first go through the phase change from frozen to thawed before microwaves can generate heat, all while the liquid surface continues to heat at a much higher rate from absorbing the microwaves present. Until the interior is thawed and frees up more water to absorb the microwave energy, the majority of the microwave energy absorption is occurring in the water closest to the surface therefore creating a large thermal imbalance.

Correctly taught in the Fumiko patent is that as food moves through different states from solid to liquid or even to the vapor transition point of water, differing energy levels are needed per unit time to effect consistent heat transfer. However, due to the fundamental inability of microwaves to impart any meaningful energy to frozen water Fumiko recognizes that the only way to determine the appropriate time to thaw a food item is experimentally and these experiments will need to be caried out for a plethora of food items making it difficult, if not impossible, to institute true automation in microwave thawing.

When using either of these conventional methods, or both, food is more dried-out than it could be with the water escaping in the form of water vapor. Furthermore, the ability to adjust heating schemes to balance heat transfer into the food is severely compromised as knowing the exact amount of heat imparted into an object is not knowable given the nature of broadband absorption and the nature of how microwaves do not impart any meaningful energy into frozen water. As such, the ability to heat the entire target consistently and repeatably to the desired heat state is nonexistent.

Hence, the presently described embodiments teach a new way of thawing, or thawing and cooking, much more rapidly than the speed at which conventional approaches are capable.

In this regard, referring back to FIG. 3, the presently described embodiments use narrow-band energy for high speed, intelligent thawing and if the same block of ice (30) is to be melted, then narrow-band energy (20) can be directed toward the surface of the ice block. The narrowband energy (20) should be chosen at a wavelength which is readily passed through the water, rather than absorbed near the surface. As the narrow-band energy (20) penetrates deeply into the ice (30) its energy (21) is directly absorbed, progressively through the thickness of the ice. The speed of penetration (21) will be at the speed of light. It will exhaust the narrow-band energy by imparting its heat into the ice block (30). From that point in time, it will continue by conductively soaking through the ice block. The narrow-band energy has had a huge head-start through the ice block. The speed of the penetration, (21) is nearly instant, to a depth of 1 to 2 centimeters. The further distribution of the heat, is accomplished by conduction, at the higher speed of the heat conduction in ice as mentioned above. This means that, not only is the initial injection of heat dramatically faster than for microwave energy, but the second stage of conduction is approximately 4× faster through the ice than the microwave generated heat travels by conduction through the liquid water.

The narrow-band energy intensity will start falling off as it penetrates and is absorbed. But at that point, a substantial amount of heat has been injected and deposited deep into the ice block (30). It penetrates a very useful distance before it has all been absorbed and the deposited heat will then rely on conduction the balance of the way as it spreads through the ice. The amount of narrow-band photonic energy that penetrates into the ice is virtually 100% converted into heat that will go toward the ultimate melting of the ice. It becomes readily apparent why using narrow-band energy dramatically improves the speed and consistency of melting when compared to the surprising amount of wasted energy from the microwaves. Also, to be considered is the fact that microwaves are actually physically large waves which exhibit the properties of waves. Therefore, the cancellation and complementary properties of microwaves can make some areas too cold while adjacent areas are too warm.

As apparent in FIG. 3, most of the microwave energy is not actually imparting its energy into the ice. When dipoles are locked in a crystalline structure like ice, they are virtually transparent to the microwave radiation. It is as if the cooking chamber is empty. The microwaves must exit through the housing, be absorbed into the chamber walls, or be coupled back to the magnetron that generated them if they cannot be absorbed by the food through dipole orientation phase lag. The presently described embodiments use semi-conductor produced narrow-band energy as the starting point and expands and sophisticates the thawing process in order to harvest the efficiency of narrowband ice melting in a variety of novel ways.

In conventional ovens and microwave ovens, energy is designed to flood the chamber or oven enclosure. Some of this energy is imparted to the target or comestible. An uncalculatable amount is lost to the surrounding atmosphere through radiant, conductive, and convective heat transfer. Unlike these ovens or heating systems, the semiconductor produced narrow-band energy can be directed exactly at the target. The amount of energy actually injected into the target can be exactingly calculated.

Ovens utilizing semiconductor produced, narrow-band energy, operate at the molecular level matching the photons of a particular wavelength to the resonance frequency of specific covalent bonds. Contrary to common belief, covalent bonds in molecules are not rigid like sticks or rods but are more like stiff springs that can be stretched and bent. As such, molecules experience a wide variety of vibrational motions whose characteristics are relative to their component atoms. Consequently, virtually all organic molecules will absorb infrared radiation that corresponds in energy to the appropriately matched vibrations.

Because of the quantum nature of light, that light comes in packets of energy, covalent bonds absorb energy from light in a quantum fashion, not linear fashion, as well. The formula is as follows:

$$E = \frac{h c}{λ}$$

Where E is the energy, h is a number called Planck's constant, c is the speed of light and λ is the length of the wavelength.

The presently described embodiments use light waves and the quantum phenomena of energy transfer from electromagnetic radiation to a molecule to bring it to an excited energy state as it absorbs the light photon. This excited energy state does not last long and when it returns to its ground state releases energy in the form of heat. Electromagnetic radiation, also known as light, is generated at specific frequencies in the near IR that correspond to the absorption harmonics that affect change in the energy state of a targeted molecule. By utilizing an overtone harmonic in the near-IR, versus the primary absorption frequency in the mid-IR, weaker absorption occurs at the covalent bond level of the molecule and therefore deeper penetration into an amalgamation of molecules occurs. The result is a usable rate of energy transfer and deeper penetration of heat into the target, such as food stuffs, can be achieved.

Unlike nature and broadband heating methods, in a semiconductor produced, narrowband energy oven, specific wavelengths can be generated to effect heating on specific molecules while avoiding others. In nature, because water is a broadband absorber in all but some of the near-infrared infrared wavelengths, all broadband heating methods tend to overly cause heating of the water in food stuffs containing water.

The mechanism of heat generation using narrowband infrared light is as follows: All matter above absolute zero vibrates. The covalent bonds within molecules resonate with certain vibration frequencies. Electromagnetic energy, also known as light, contains quantum packets of energy vibrating relative to the light's frequency. Absorption of light within matter, regardless of the wavelength, is based on the quantum vibrational states of the material being illuminated. In organic material, the primary vibrational state typically corresponds with mid-infrared wavelengths. The ability of photons from near-infrared light to be absorbed by an organic molecule is much weaker in intensity as compared with wavelengths in or closer to mid-infrared light frequencies. This is due to the near-infrared wavelength being an overtone, or harmonic, to the primary mid-infrared frequency that matches the particular quantum state or vibrational level of the electrons in the covalent bonds in the organic molecule. As such, light generated in the near-infrared range provides a unique opportunity to match specific wavelengths of energy to specific covalent bonds to effect absorption at a rate that allows for deep penetration into an amalgamation of molecule such as food stuffs while avoiding unwanted heating effects on other molecules such as water.

As an example, in the approximate 2.7 to 3.3 micron range the O—H covalent bond in molecules such as water, H₂O, and the N—H covalent bonds achieve maximum stretching vibration from the quantum energy delivered at this frequency. As such water exposed to electromagnetic radiation of 3 microns absorbs and quickly converts all light energy at this wavelength into heat with almost zero penetration beyond the surface.

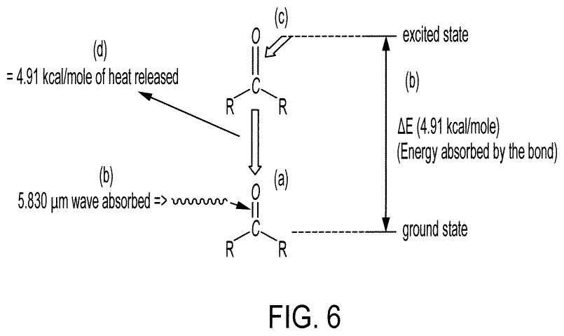

To further illustrate this phenomenon, a simple line drawing can be used to express the mechanism of how the molecule absorbs the energy and releases it as a particular wavelength imparts energy to bring a molecule to an excited state and then the molecule returns to a ground state as it releases energy in the form of heat. In this diagram, C represents Carbon, O represents Oxygen and R represents a continuation of the molecule. This particular covalent bond, a carbon oxygen double bond, has a high propensity to resonate with and absorb the quantum packet of energy at a wavelength of 5.830 microns. This wave has a frequency of 5.15×10¹³ Hz. Using the above equation, the energy imparted at this wavelength is 4.91 kcal/mole. FIG. 6 shows (a) the molecule in its ground state, and (b) the absorption of the quantum energy from the 5.830-micron wavelength and the associated 4.91 kcal/mole of energy in the quantum packet. The excited state (c) shows the elongated carbon-oxygen double bond representing one of the six vibrational states identified followed by (d) the release of energy in the form of heat as the molecule transitions from its excited state to its ground state. As intended in this diagram, the bond targeted is very specific, in this case the carbon-oxygen double bond, and corresponds with a very narrow frequency range a few hundred nanometers across.

Using narrowband infrared light at a known rate of energy injection is a dramatically improved method of thawing food. Furthermore, using a source with a known energy output directed at the target allows for the precise heat needed to effect change in the foodstuff from frozen to thawed with minimal increase in temperature of the actual frozen food tissues. Because frozen foods have high thermal conductivity, heat transfer and therefore the ability to thaw a food product can be very quick when accomplished by injecting heat directly into the food target through the mechanism of targeting and vibrating the covalent bonds in the food molecules as noted above. This bypasses the boundary layer that slows the process in convection cooking. Because change in temperature is a key variable in calculating thermal flow, by monitoring the change in surface temperature with respect to the rate energy is injected into the target, the change in energy injection needed to maintain a set surface temperature can be used to approximate thermal equilibrium within the target. The change in temperature relative to the rate at which energy is injected into the target, can also be used to identify phase change from solid to liquid. This provides yet another advantage over traditional thawing techniques wherein a frozen item can be placed inside of a refrigerated area. Narrowband energy can then be directed at the food target and applied until the food target has transitioned through a phase change to a thawed state without increasing the temperature of the food item above that of the refrigerated area. In addition, the energy can be specifically directed at the food target imparting energy only to the food target and not causing other items in the refrigerated area to increase their heat profile.

As noted above, the presently described embodiments relate to a novel way of thawing or cooking various frozen foods using narrowband energy to execute the thawing and/or cooking process more efficiently and effectively than could be achieved in heretofore conventional techniques. In at least one form, this includes obtaining information in the thawing process that is used as feedback and control for an improved subsequent process, e.g., a cooking process. Further, in at least one form, when either thawing or cooking or both, it will be appreciated that the presently described embodiments gather information during the process and use such information for feedback and/or control. In this regard, it should be appreciated that, in at least one form, the presently described embodiments include detecting, by at least one sensor positioned in an irradiation area and operatively connected to a control system, at least one physical property of at least one of the food item, the irradiation area or an environment during a heating process. This physical property (or properties) is translated to at least one measurement. The physical properties and measurements, and translations to measurements, will vary according to implementations, as described in the example implementations herein. Cooking instructions are executed to achieve certain objectives, such as desired state and temperature or other objectives, in accordance with at least one of: the at least one physical property detected by the at least one sensor positioned in the system or the at least one measurement. That is, the cooking instructions are executed, in accordance with at least one of: the detecting or the translating.

In this regard, with reference back to FIG. 4, again, the energy (43) which is needed to melt the frozen ice (42) into liquid water (44). It takes the same amount of heat energy (43) to convert ice at 32 degrees F. (42) to water at 32 degrees F. (44), as it does to raise the temperature of liquid water from 32 degrees F. (44) to 175 degrees F. (49) which energy amount is shown as (51).

This phenomenon yields useful information that heretofore has not been utilized in any conventional cooking process. That is, knowing the amount of power that can be imparted per unit area to the targeted ice block or to frozen food, allows for algorithms to be implemented in the control system of a narrow-band oven which will facilitate much further optimization of the narrow-band thawing or cooking process. Infrared sensors or infrared cameras can monitor the surface temperature of the ice. If the ice block is below 32° F. and rising in temperature at the surface, then it can be deduced that the ice has not yet reached 32 degrees. If energy is going in, but the temperature is not rising, it must be going through the heat of enthalpy. Once the temperature starts to rise again, there is now new and very useful data as to how many joules of energy can be injected into the target to cook it a certain way. It is even possible to derive how to properly cook the food by watching how the temperature changes as the target comestible is brought up through its melting point and through the phase change of melting its ice crystals. It is valuable in a variety of ways to watch how the temperature changes through the different stages of the process, given the known energy production of the semi-conductors.

A narrow-band oven has another huge advantage over traditional ovens. One can calculate how much heat energy is actually being produced and how much of that is being injected into the target or frozen comestible. By knowing how many joules of energy that the oven is imparting to the ice/food target and knowing the rate of temperature rise (T), as compared to a known or model example and knowing the expected rate, algorithms are implemented in the system according to the presently described embodiments. They calculate, based off the variance of actual to expected, what heating recipe is needed to bring the target up to a specific finished temperature at the center of the target. This is desirable because it enables automated heating, thawing, and cooking.

By knowing the joules of energy that have been injected into the overall, larger target environment, monitoring the oven walls temperature with sensors as a function of time, monitoring the temperature of the target food item as a function of time with infrared sensors or a camera, and knowing the geometrical shape of the target with sensors, metrics about the thawing process are available to the system. Thus, knowledge is gained that, according to the presently described embodiments, is used in a subsequent process, e.g., a cooking process.

In this regard, for example, it will be known when the target comestible item has thawed and how many joules of energy must continue to be injected in order to keep the comestible on a desirable, e.g., perfect, “cooking speed slope” after thawing-thus, achieving and maintaining a desirable, e.g., a perfect, internal temperature to result in improved, e.g., optimal or near-optimal, taste. The cooking speed slope may vary by preference of end result or by the characteristics of the comestible being cooked, but controlling the slope can result in improved, e.g., ideal, cooking. The temperature profile can be controlled through the thickness of the comestible's profile. For example, if 141 degrees F. is the optimal temperature all the way through for a steak, then that can be maintained to completion of the cooking process. The cooking speed slope is very difficult to maintain with traditional cooking, but using narrow-band cooking in connection with the presently described embodiments, the cooking slope can be held and modulated as needed to keep the slope where it is desired, thus cooking to an improved, e.g., ideal or near-ideal, end result.

The presently described embodiments may be implemented in a variety of advantageous manners. For example, generating an instant on/off, narrowband energy at 990 nm+/−6% provides a method to consistently adjust the exact energy needed to take food through each phase change from a frozen state to fully cooked. At this wavelength, infrared light energy will bypass the boundary layer and penetrate the food target up to 2 cm as it converts to heat by direct absorption into the food. Also, the instant on/off infrared photonic radiation or light illumination of the target can precisely generate heat within the target. Exact heating schemes can be created to heat food targets in any state consistently whether frozen or thawed, to the desired outcome. Using the thermal absorption characteristics of the food, energy can be applied at one rate to take the entirety of the food product through the phase change from solid (frozen) to liquid (thawed). Energy input can be balanced to the heat transfer rate of the solid food item. Another rate of energy injection can be used to consistently heat the food once thawed and would correspond to the heat transfer rate of the thawed food. In such a scheme, the infrared illumination could be up to four times the concentration in the frozen state as the heat transfer rate of ice is four times that of liquid water. In this regard, in at least one form, it might be desirable to just thaw and hold. The lower energy injection ensures the target comes to temperature slower not affecting the refrigerated environment. If just thawing and immediately cooking, a minimum for thawing could be 4X that of cooking if trying to optimize for time. It is not always desirable to optimize for time.

Further, unlike conventional broadband heating during which air gaps in the food act as insulators, narrowband heat injection allows for the energy to pass through the air gaps heating only the food target. As such, all one needs to effectively heat food is the state of the food (thawed or frozen), the mass of the food, and the type of food. Using known thermal properties dictates the amount of light energy or joules needed to heat the food to its target temperature. In this regard, although it varies depending on the exact type of food item, most food items have a predictable amount of water, proteins, fats, carbohydrates, and ash as part of their composition. Ash is defined as the minerals and inorganics left over after removing moisture, volatiles, and organics. Oils have very low ash concentrations approaching 0%. Meat typically has the highest at over 12%. At specific narrowband wavelengths as defined above, these elements that make up food have specific absorption characteristics that can be used to precisely apply heat into the target. In addition, the energy needed to melt ice is less than one sixth that needed to boil water (334J to melt 1 g at 0° C. versus 2260J to evaporate 1 g at 100° C.). As such, variations in the target composition will not dramatically affect the moisture content of the thawed portion of the target as the remainder is brought through the phase change to a thawed product.

As a further alternative, thermal sensors can also be added to monitor changes in temperature of the surface as part of a feedback loop to automate the heating process. Unlike microwave heating which begins to heat by exciting the water molecules on the surface which in turn heat and melt more water within the food target, or conventional broadband heating where the air heats the surface of the food target up to the boiling point of water and in turn the surface molecules slowly diffuse heat towards the center of the food target, narrowband heat injection penetrates the food target regardless of the state, frozen or liquid, of the water molecule by vibrating very specific covalent bonds in the water molecules or the molecules that make up the food target. As such, the rate of change of surface temperature over time can be used as a feedback loop to adjust energy input to ensure temperature penetration as well as phase change from frozen to thawed. Ice has a thermal conductivity of roughly 2.2 to 2.4 W/m·K at typical household freezer temperatures. Water has a thermal conductivity of less than 0.6 W/m·K. As such, food in its frozen state can have up to approximately 4 times the energy injected compared to thawed food to maintain a consistent heat temperature profile through the food. Accordingly, a power scheme can be developed for a known food item to increase the power density while frozen and then modulate the power input to maximize heat transfer into the thawed food to effect cooking.

Because thermal flow is from hotter areas to colder areas, by calculating the amount of heat injected into a substance and calculating the depth of absorption, a theoretical surface temperature can be calculated. The difference between theoretical and observed would be the heat diffusing to the colder center of the target. Modulating the heat injection such that the surface temperature remains close to, but never exceeds a target temperature will optimize heat flow to the center of the target. Because change in temperature is a key variable in calculating thermal flow, by monitoring the change in surface temperature with respect to the rate energy is injected into the target the change in energy injection needed to maintain a set surface temperature can be used to approximate thermal equilibrium within the target.

It should now be appreciated that the presently described embodiments will enhance and improve the cooking and thawing process for foods in a variety of ways. For example, flavor is enhanced by implementations described herein. More particularly, flavor is a key component in determining a successful cooking result of any comestible. Flavor is one of the factors most dramatically, and negatively affected, by broadband and RF heating and cooking. Flavor perception is the sensory impression of food or any other chemical substance, determined by chemical reaction with the senses of tastes and smell (1). Water soluble and volatile flavor-active aroma compounds are key components of food as they contribute to the perceived quality of the final product.

Flavor is a key component that is impacted by the inconsistent heat application of current cooking methods. Too little heat could result in the spices not achieving their full potential. For example, herbs and seeds like cumin, coriander, anise, caraway, and poppy are enriched by cracking, toasting, mincing, or crushing to release essential oils and aroma. Too much heat and the delicate balance is disrupted. The flavor from the spice could be lost, or undesirable and bitter flavors and/or aromas could result. For example, some spices like cloves, nutmeg, turmeric, cumin, cayenne, paprika, and curry blends scorch easily and become bitter if overheated. As such, it is imperative to heat seasoned food with care.

As noted above, the inconsistent application or variable generation of heat using traditional methods makes it difficult to maintain the difficult balance of heat needed to optimize flavor in spices. Inconsistent heat can even damage the molecules degrading them into something undesirable and bitter. Flavor is also lost using these traditional methods when the molecules that create the flavor sensory sensation are lost with the water they are dissolved into as it evaporates into the air. These molecules lost to the air trigger our olfactory nerves and are sensed as smells and food odors. As such, through recorded history, flavor enhancements have been used to compensate for the loss of flavor molecules or have been used to mask the damaged molecules which cause undesirable characteristics such as bitterness.

Over the history of food cooking, flavor compounds have been isolated, concentrated and added back to the food to mask the damaging effects of uneven broadband cooking and most recently, the damage caused by RF cooking. Flavor enhancers come in the form of sauces, bouillon, and other plant or animal-based concentrates. These enhancers operate by adding back molecules to increase taste or adding molecules to mask undesirable features of the cooking method. Many food ingredients, including monosodium glutamate (MSG), table salt (NaCl), and sweeteners have been termed ‘taste enhancers’ but their main effect is simply to add more molecules that generate additional taste or smell sensations. These ingredients don't actually boost chemosensory properties but rather contribute to additional savory, salty, or sweet properties.

MSG is a taste enhancer strictly from the standpoint that it adds another taste quality to the food which improves palatability rather than altering the intensity of other ingredients. Similar conclusions pertain to the ‘enhancing’ effects of NaCl and sweeteners that add saltiness or sweetness to food, respectively; they also improve palatability by reducing bitter components of some food substances. Thus, MSG, salt, and sweeteners are taste enhancers from the standpoint that they add additional tastes to the food and improve palatability rather than potentiate the taste intensity of naturally occurring, native, or other ingredients.

As discussed above, broadband heat and RF microwave ovens have the undesirable effect of heating the water molecules in the food target causing the water to evaporate or boil away. In turn, these water molecules carry with them key flavor molecules as they exit the comestible and disperse into the atmosphere. Because of this phenomenon, taste enhancers have become the method to ensure food stuffs achieve desired taste profiles for consumption. The complexity of balancing these taste enhancers with the cooking method and comestible flavor profile further adds to making food preparation time consuming, inconvenient, and requiring skill to produce consistently satisfactory results.

Another aspect of being able to produce consistently satisfactory results when cooking is related to the texture of the food. Food texture, or mouthfeel, has many definitions, but most can be reduced to the perceived feeling the food causes while humans consume it. Key attributes based on physical and sensory attributes are hardness, adhesiveness, cohesiveness, springiness, gumminess, brittleness, chewiness, and viscosity. In each instance listed above, the amount of water present and the perceived fattiness in the comestible has an impact on the attribute and therefore the perceived quality of the finished product.

A key component of texture in cooked meat is perceived tenderness. Two major factors influence meat tenderness: the condition of the myofibrils (Myosin proteins and Actin proteins are two key proteins responsible for juiciness and toughness), and the condition of the connective tissues. When these proteins are not constricted, and the connective tissues break down, the meat is perceived to be more tender.

These proteins in meat are dramatically impacted by cooking temperature. At various temperature ranges the proteins change in firmness as well as in their ability to retain water. The Myosin protein filament begins to denature around 104° F. (40° C.) with a striking change at 122° F. (50° C.) in which it contracts the muscle fiber shrinking the sarcomere in diameter. At this point using broadband or RF heating the muscle fibers are firmer, but still considered tender. Relatively little water has been driven out of the cells by the contraction of the Myosin protein. At these temperatures, relatively little water has also been driven to the surface and evaporated away.

The Actin protein filament begins to denature at 150° F. and continues through 163° F. (66-73° C.) (5). During this temperature transition the protein fibers become very firm, shorten in length, and expel a lot more liquid from the muscle cells. In traditional broadband or RF heating, the muscle fibers are tough and have expelled liquids once the Actin proteins start to denature. At this point, water has been squeezed from the muscle structure and is in a freer form to evaporate. Water molecules are highly absorptive in the wavelengths generated by broadband heating and are easily excited, disproportionately heating the water molecules and driving them out of the meat, making the meat tougher and hard to chew. Thinner cuts of meat become dramatically tougher and dryer at this elevated temperature as the water has a more direct route to exit the meat.

With the exception of most fish which have relatively low connective tissues in their flesh, there is one other key temperature range when cooking meat that affects texture and flavor. At 160-205° F. (71-96° C.) the collagen in the connective tissues begin to liquify and form gelatin. This action lubricates the muscle proteins creating a moist texture and a flavor that can be described as succulent. As the connective tissues soften, the meat becomes the most tender. Large and tough cuts of meat may be cooked to these temperatures to add the unctuous flavor of the collagens and to maximize tenderness, but using broadband and RF heating methods, this elevated temperature comes at the cost of driving off water and the associated flavor molecules and nutrients which are dissolved in the water.

As noted above, due to the flavor loss that occurs when using broadband or microwave (RF) oven heating, flavor enhancements need to be added back to the food being cooked. One such flavor enhancement happens when the outer skin of meat or fish is cooked at a high enough temperature to initiate the Maillard reaction, also known as pyrolysis or browning. It occurs when the outer skin has the water or moisture driven out by evaporation through the cooking method and amino acids and reducing sugars are heated together at temperatures between 284-330° F. (140-166° C.). Although this reaction produces chemicals that add flavor, it also has a side effect of producing Heterocyclic Aromatic Amines, referred to as HAAs, or HCAs.

The production of HAAs is yet another disadvantage of broadband cooking. Not only does this type of cooking drive flavor loss as noted above, but in order to achieve desired internal temperatures the outer temperature of the food target is elevated as part of the cooking mechanism. This elevated temperature promotes the formation of HAAs. The National Cancer Institute warns that meats cooked at temperatures above 300° F. or those cooked for a long time tend to form more HAAs. These compounds have been found to sometimes cause cancer in animals during lab experiments, and the World Cancer Research Fund/American Institute for Cancer Research recommends limiting consumption.

Don W. Cochran et al. in U.S. Pat. No. 10,687,391 teach how using narrowband infrared (IR) heating sources in the near IR bandwidth can provide efficient and effective deep heat penetration into food objects. By radiating electromagnetic energy at a wavelength that corresponds to the absorption spectrum of the specific material being heated, heat generation and heat penetration generated by the heat exchange of energy by photons into the object can be optimized.

In addition to those teachings, the presently described embodiments allow for not only the careful selection of the wavelength for the desired amount of absorption, but also for selection of narrowband IR heating wavelength to specifically miss key absorption spectrum characteristics of water. This approach can minimize water heating effects and minimize water loss due to evaporation while cooking. Also not taught is that water is a key carrier of flavor and nutrient components. Further, the evaporation of the water using traditional broadband heating methods and microwave oven heating methods carries with it the flavor molecules in the form of smells while cooking as well as water soluble nutritional components of the comestible.

Properly tuning a narrowband IR heating source to emit wavelengths that are not readily absorbed by water results in minimizing flavor loss and nutrient loss in the food target. Water has very specific absorption characteristics in the IR light spectrum. As an example, from the wavelength of 720 nanometers (nm) to approximately 1180 nm very little infrared energy is absorbed by water. However, comestibles comprised mostly of water such as beef (over 70% water), chicken (over 70% water), salmon (over 60% water), and broccoli (over 90% water), listed as just a few representative examples, are dramatically more absorptive of photonic energy in this wavelength range. As an example, beef, chicken, and salmon are over nine (9) times more absorptive of energy in these wavelengths and broccoli is over five (5) times more absorptive and readily convert the photonic energy into heat.

By providing a thermal IR heating system capable of generating radiative heat within the bandwidth of 720 nm to 1180 nm, or from the upper limit of the visible wavelength range to approximately 1180 nm, with an irradiation source of any increment from 1 nm wide to the full 460 nm wide range, the target comestible can be heated without unduly heating the water. It should be appreciated that the irradiation may be continuous or pulsed depending on, for example, the environment and/or implementation. This provides many advantages. One advantage being that water can be maintained well below its boiling point at all points during the cooking operation, maximizing liquid retention.

The use of Narrowband Radiance or Radiation Emitting Devices (NREDs) in the output range noted above provide the advantage of water retention, and therefore improved quality and nutrient content, while optimizing heating penetration and photon to heat conversion efficiencies. Furthermore, the narrower output ranges of some of the NRED devices allow even more specificity in targeting smaller peaks or troughs of absorption within the above noted range affecting the penetration of energy into the comestible so that the comestible can be heated to specific, desired, outcomes. While a variety of different narrowband sources (such as light emitting diodes (LEDs), laser diodes such as surface emitting laser diodes, or other devices that emit energy or irradiation in a sufficiently narrow wavelength) could be used to implement the presently described embodiments, one example (e.g., NRED) that could be used (with appropriate modification, if necessary) to implement the presently described embodiments is described in co-pending, commonly owned U.S. application Ser. No. ______ filed ______ (Atty Docket No. PTIP 200138US01) (listing Don W. Cochran, Mark F. Fleming, and Steven D. Cech as inventors) and entitled “NRED Oven Device”, which application is incorporated herein in its entirety by reference.

Typical NREDs can comprise multiple digital devices. Laser Diodes are such a device which typically emit a spectrum wavelength range measured at Full Width at Half Maximum (FWHM) of approximately 1 nm to just over 10 nm. Radiance emitting semiconductors also known as Radiance or Radiation Emitting Diodes (RED) also typically emit a narrow band spectrum wavelength. FWHM spectrum wavelength ranges for REDs typically range from just under 25 nm to just over 75 nm.

It should be appreciated that the various forms of NRED devices contemplated herein, in at least one form, utilize a current control system. In at least one form, the system (or current control system) continuously controls or limits the current (e.g., amperes of electrical current) that is supplied to the NREDs, or arrays of NREDs. In this regard, the system or control system is, in at least one form, operatively connected to at least one Direct Current (DC) power supply. The DC power supply, in this case, for example, is operatively connected to the array(s) of NREDs. Or, the system or control system may also be connected to a power supply used in conjunction with at least one electrical component which limits the current the at least one array of NREDs.

In traditional broadband heating methods, a surface, or a chamber is heated well above the boiling point of water. The majority of heat used to heat the food target is then transferred into the food through conduction if placed on a heated surface or through convection if placed in a heated chamber. Heat transfer in the direction from the hot surface or hot chamber to the colder food target occurs. The outer most layer of the food increases in temperature until it reaches the boiling point of water (212° F. (100° C.) at 1 atmosphere of pressure) and the energy begins to convert the liquid water into water vapor. Any temperature differential in the food will also cause energy to flow from the warmer part of the food to the cooler. The energy from the hot surface is being used to convert water from liquid to vapor and to raise the temperature of the food target until it reaches the boiling point of water.

Evaporation is a function of vapor pressure at the surface. Because implementations of the presently described embodiments do not heat the boundary layer from the oven chamber, vapor pressure in the boundary layer is not adversely affected, further decreasing the rate at which water evaporates at the surface when below its boiling point.

As the surface of the food target heats and evaporates off the outer layer of water, free water from within the food is driven towards the surface through capillary action and is in turn converted to vapor. If the food target is a meat, the Myosin proteins and the Actin proteins noted above constrict, further freeing up water that is driven towards the surface through capillary action and evaporated as the liquid water on the surface is vaporized. This water, as it is driven towards the surface, carries with it dissolved ions as well as volatile and aromatic compounds comprising various flavor and nutrient components. These ions and compounds are expelled into the air transferring flavor from the food to the smells associated with cooking while dissipating the associated nutrients.

Unlike broadband heating of water in which liquid water absorbs energy and increases temperature until it reaches its boiling point, or RF heating where the microwave overly excites water causing it to vaporize, heating using narrowband infrared energy in the bandwidths from 720 nm to 1180 nm has little effect on the enthalpy or entropy of the water when compared to other wavelengths in the near IR, short-wavelength IR, and mid-wavelength IR spectra ranges. When heating food stuffs, relatively all energy transfer to water in this narrow, 460 nm wide range comes from the conductive heating of the water by the other components that make up the food target, or the container in which the food target is placed. As target temperatures of comestibles is dramatically below the boiling point of water, the result of narrowband radiance heating in the 720 nm to 1180 nm range is that relatively no water is boiled away, little water is evaporated, minimal capillary action occurs to move water to the surface, and loss of flavor and nutrient components are dramatically reduced. In turn, these molecules are not released to the surrounding air in which they can be perceived as smell.

Narrowband infrared energy heating in the bandwidths from 720 nm to 1180 nm has an additional advantage over traditional broadband heating. At these wavelengths, photonic energy penetrates the food target and is converted to heat, bypassing the associated thermal boundary layers created using convective heating. The property of a boundary layer is that it dramatically decreases fluid flow (until it reaches zero at the ultimate point of contact with the food target) and as such dramatically impedes thermal transfer. (This phenomenon can be directly experienced by placing a hand inside a 350° F. oven. Heat is felt, but no physical damage is noted to the skin or hand. Placing that same hand in oil at 350° F. would result in near instant catastrophic damage as the boundary layer is minimized and heat transfer is near instantaneous). By bypassing the boundary layer and its associated insulation properties, heat injection into the food is dramatically increased in turn dramatically decreasing the time needed to bring the food target to temperature. Decreasing the time the food target is being heated minimizes the time in which capillary action can occur, minimizing the mechanism in which water from within the food is brought to the surface. With the loss of water, water soluble vitamins such as vitamin C and the B vitamins—thiamine (B1), riboflavin (B2), niacin (B3), pantothenic acid (B5), pyridoxine (B6), folic acid (B9), and cobalamin (B12), as well as minerals such as potassium, magnesium, sodium, and calcium are lost. These are just a representative sample of the water-soluble nutrients lost using conventional cooking methods. The vitamins and minerals are entrained in the water and as such are driven to the surface of the food and lost as the water evaporates and boils off. The longer the comestible is under heat, the more capillary action brings water to the surface, and with it, vital nutrients which are lost to the medium in which the food is being cooked. By increasing the speed of cooking and not heating the water in the food, capillary action is reduced, and vitamins and nutrients are retained.

There is an additional advantage of being able to maintain relatively more water and, therefore, more flavor molecules in the comestible when heating with narrowband IR radiation in the 720 nm to 1180 nm range when compared to broadband heating. As noted above, when a comestible has amino acids and reducing sugars present and they are at temperatures between 284-330° F. (140-166° C.), a chemical reaction occurs commonly known as the Maillard Reaction. It is a thermal process in which amino acids and sugars produce a mixture of complex compounds. These compounds produce changes in sensory attributes such as color, flavor, and aroma. Temperature, time, pH, and water all affect the reaction. As noted above, a byproduct of this reaction can also be HAAs or HCAs.

The initial mechanism of the Maillard reaction involves the carbonyl group of the sugar reacting with the amino group of the amino acid. This interaction releases water and creates N-substituted glycosylamine. The second compound is unstable and rearranges further releasing two molecules of water. Following these two reactions, the resulting compounds react through several pathways creating the myriad of compounds that generate the resulting color and taste. It is important to note that water is a key biproduct of the first two reactions. The elevated presence of water before the reaction will therefore retard and dramatically curtail the reaction.

Heating foods, using semiconductor generated, narrowband, infrared radiation in the 720 nm to 1180 nm wavelength range, has the benefit of improved moisture (also known as juiciness) as well as improved flavor as described above. It also has the benefit of being able to impede the Maillard reaction and the associated creation of HAAs and HCAs. By using digital semiconductor based narrowband devices of an instant on and instant off nature to generate narrowband infrared radiation, temperatures of the food target can be precisely controlled and maintained well below the temperature range in which the Maillard Reaction is most active. As taught above, the added water remaining in the target further impedes the reaction reducing or eliminating the production of HAAs and HCAs.

Due to cooking traditions and due to expected and even desired flavor profiles, at times it might be advantageous to allow for the Maillard Reaction when cooking. Cochran et al. in U.S. Pat. No. 10,687,391 identify multiple patents that recognize longer wavelengths in the IR spectrum are generally absorbed closer to the food surface. There is general agreement that this higher absorption is generally above 1400 nm. Cochran et al. further teach that there are micro-troughs and micro-peaks in the energy absorbed by various food stuffs at various wavelengths. The presently described embodiments take advantage of these troughs and peaks to impede or accelerate the Maillard Reaction and/or caramelization.

Caramelization is a nonenzymatic process of breaking down sugar using heat so that it loses water and reformulates into complex polymers and aromatic compounds having a range of complex flavors and smells. If caramelization proceeds too far, the taste can become bitter as too much of the original sugars are destroyed. Much like the Maillard Reaction, a key byproduct of the caramelization reaction is water. As such, water content and heat directly affect the reaction. Temperatures of caramelization of sugars are as follows: Fructose, 230° F. (110° C.); Galactose 320° F. (160° C.); Glucose 320° F. (160° C.); Lactose 397° F. (203° C.); and Sucrose 320° F. (160° C.). Many foods contain both sugars and amino acids. As such, browning is typically a combination of the Maillard reaction and caramelization.

Tight control of temperatures using digital, semiconductor based, instant on and instant off, narrowband radiant heat generating devices can be used to balance browning or pyrolysis action caused by caramelization or the Maillard reaction. Using wavelengths in the 720 nm to 1180 nm range minimizes water loss impeding both the Maillard Reaction and caramelization. Conducting the majority of the heating or cooking operation on foodstuffs using semiconductor NREDs of these wavelengths will allow for complete cooking of the target without any browning of the target. Further balancing energy transfer into the food stuffs based on its energy absorption characteristics and its thermal diffusivity will ensure even heating or cooking without browning the surface. (A material's thermal diffusivity is its thermal conductivity in relationship to its density and heat capacity. Heat capacity is the amount of heat needed to change the temperature. The thermal diffusivity therefore is the ability for that heat to move through the material of a given density).

When caramelization or the Maillard Reaction is desired, NREDs radiating in the 1380 nm to 1580 nm range can be used. Radiance in this wavelength takes advantage of a micro-peak in which water, proteins, and vegetable fibers absorb energy at over five (5) times the rate absorbed in the 720 nm to 1375 nm range. When illuminated in this wavelength range, surface water is quickly heated and evaporated away from the surface allowing for the chemical reaction of the Maillard Reaction as well as the chemical reaction of caramelization to occur. The remaining surface material is also quickly heated to temperatures that initiate the Maillard Reaction and caramelization. Also, in accord with the presently described embodiments, cooking instructions are, in at least one example, executed to increase surface temperature of the comestible target to a temperature above 397° F. (203° C.) while heat generated from application of the narrowband wavelength operative in the 1380 nm to 1580 nm range does not affect a heat rise in a majority of the comestible target by more than 5° F. (2.8° C.) while under irradiation from the at least one array of NREDs operative in the 1380 nm to 1580 nm range. Further, in at least one embodiment, the NREDs having a FWHM wavelength spectrum width of less than 80 nm and an output peak wavelength in the 720 nm to 1180 nm range can be further paired with at least one NRED having a FWHM wavelength spectrum width of less than 80 nm and an output peak wavelength in a range of 1380 nanometers to 1580 nanometers.

A key advantage of this type of illumination is that by minimizing time under illumination, or the intensity of the illumination, heat imparted into the target is minimized and both reactions can be controlled for desired results. Because the semiconductor produced light is digitally generated (instant-on, instant-off) the degree of browning or caramelization can be tightly controlled. This method of browning minimizes the production of HAAs and HCAs.

Another advantage to this type of browning is that the reaction is relatively fast compared to browning caused by broadband heating. Although water is expelled at the surface, the browning reaction occurs nearly instantaneously with the water extraction. The result is that there is not enough time for the capillary action to occur to bring water from deep in the center of the target to the surface. The result is more water content that remains in the comestible which in turn leads to juicier and tastier food stuffs.

In addition to taste and texture degradation issues noted above as water is expelled as a byproduct of cooking with traditional (broadband) and RF (microwave) techniques, the loss of water and flavor molecules also result in odor molecules being expelled into the surrounding area. Some of these scents are advantageous in that they trigger food memories, food decisions, and stimulate appetite as well as provide insight into potential flavor, quality and whether a food is even edible. Other aromas may linger causing kitchens and surrounding areas to smell stale and unpleasant.

Common thought is that smell is a precursor to taste. While true, the most important part of the aroma-taste interaction actually happens while we are chewing. A channel connects the roof of our throat to the olfactory receptors in our nose. As we chew, the volatile and aroma-enhancing compounds in the food are broken down by both the mechanical action of our teeth and the chemical action of our saliva. We even continue to experience the smell of food as we swallow. When this olfactory channel is blocked, your experience of flavor is greatly diminished. A plethora of research has shown that the tongue may convey taste to the brain, but how that taste is interpreted is significantly affected by the neurons that interpret odor. As such, key food odorants are important for the detection, recognition, and evaluation of food.

To create desirable flavor profiles, particularly with the advent of industrial food manufacturing, fragrance enhancers have been added to most processed food. These fragrance enhancers consist mainly of esters as well as essential oils and other aromatic compounds and are used to provide flavor consistency as well as to mimic natural flavor profiles for flavor enhancement through olfactory stimulation. Although originally these fragrance enhancers were man made, consumers are demanding cleaner labels and more natural products. As such, fragrance enhancers have been extracted and concentrated from natural sources to be used to enhance other natural scents or flavors. An example of this would be the addition of Zingerone (4-(4-hydroxy-3-methoxyphenyl)-2-butanone) to raspberry ketones. Raspberry ketones are expensive. By adding the above zingerone compound, the expensive ketones can be dramatically reduced and the aroma and therefore the flavor dramatically enhanced improving the end user's enjoyment when consumed. Similarly, if cooking methods did not release fragrance enhancing compounds naturally found in the food during cooking, more would be available to be released at the point of consumption, where they simultaneously trigger the olfactory receptors as well as the flavor receptors, in turn enhancing flavor and ultimately enjoyment of the food consumption. Much like with flavor compounds, heating food using narrowband infrared energy in the bandwidths from 720 nm to 1180 nm has the above stated advantage of not directly and therefore absolutely minimally heating the water in the food product and therefore retaining more of the water and soluble fragrance enhancers in the food. The less water that is evaporated away the more flavor compounds are retained, but it also retains more of the compounds that contribute to the aroma.

Heating using narrowband infrared energy in the bandwidths from 720 nm to 1180 nm has in addition to the advantage of maximizing the food's aroma in the final cooked product so it can be released at the point of consumption as noted above. It also has the significant advantage of minimizing undesirable smells associated with cooking some foods from being released into the kitchen and surrounding areas. An example of undesirable smells would be seafood. Even lovers of seafood tend not to enjoy the odors associated with cooking it when using conventional heating methods. Many people detest the lingering smell of fish in their home after cooking it, and some even avoid cooking fish in their homes at all because of this problematic issue. As an illustrative example, saltwater seafood tends to be high in trimethylamine, the chemical associated with a rotten or decaying fish smell. Trimethylamine is a volatile organic compound with a boiling point of 37° F. (3° C.) that is classified as being very soluble in water. It is also highly detectable as an odor by the average person at levels as low as 0.47 parts per billion. Traditional broadband, as well as RF (microwave), heating methods overly heat the water as noted above expelling it into the surrounding area along with the highly soluble and volatile trimethylamine. Once released from the water, the trimethylamine becomes gas and quickly permeates the surrounding areas. In contrast, by using narrowband infrared energy in the bandwidth of 720 nm to 1180 nm and maintaining the food target temperature well below the boiling point of water, using instant on, instant off semiconductor produced energy, minimizes water release, keeping the trimethylamine in solution and the surrounding area virtually fish odor free. This solves a major and long-standing problem with cooking fish.

The immediate value of an odor free kitchen can easily be contemplated for household cooking. There are a plethora of home remedies touting their ability to remove or cover up fish smells from the home. As noted, it is substantially more beneficial to prevent the release of the smell in the first place rather than try to remove or cover it up later. There is also high value in commercial operations. Ovens advertised as low odor in the commercial foodservice market utilize catalytic converters to neutralize cooking odors after they have been released.

John W. Robinson, Jr in U.S. Pat. No. 8,418,684, and Allera et al. in U.S. Pat. No. 6,437,294, and Norris et al. in U.S. Pat. No. 6,131,599, and Pool III et al. in U.S. Pat. No. 6,058,924, and Gelineau in U.S. Pat. No. 4,831,237, and Davies et al. in U.S. Pat. No. 4,138,220, and Burstein et al. in U.S. Pat. No. 3,785,778, and Scofield in U.S. Pat. No. 2,862,095 teach vapor purifying of undesirable odors or chemicals from the exhaust air from a cooking chamber using heat for pyrolytic conversion to less odorous and less volatile chemicals using processes such as a thermal plenum or heated catalytic conversion. What they did not teach, nor did they contemplate was a heating or cooking method that would minimize the creation of or the expelling of undesirable odor compounds into the cooking chamber over the course of cooking, thus reducing or eliminating the need to further treat the chamber's atmosphere or discharge or filter room air after the release.

Not generating cooking odors when heating or cooking comestibles has particular value in commercial foodservice. Odor control when heating or cooking is of particular concern in these operations as witnessed by the plethora of high-speed cooking ovens that contain catalytic conversion devices in their flue plenum. High volume food preparation establishments open for public on-premise consumption try to maintain an atmosphere consistent with their brand. They try to tightly control odors from cooking. As an example, bakeries or coffee shops would not want to smell like cooked fish or seared beef. It would trigger flavor cues incongruent with their primary product offering. As such, these types of establishments tend not to offer comestibles with strong odor profiles. By minimizing the release of scent enhancing chemicals while cooking, not only does the establishment have the benefit of perceived tastier food at the point of consumption, as noted above, but it also has the benefit of being able to maintain or create a desired scent profile for their establishment. And although these establishments may have ovens equipped with catalytic converters to minimize odor profiles from cooking that may contaminate the desired store scent profile, these catalytic converters can be overwhelmed by high aroma compound loads during heavy cooking operations or highly odiferous foods. Minimizing the release of the foods' scent, or essence, during cooking through the novel utilization of narrowband infrared energy in the bandwidths from 720 nm to 1180 nm, allows for the flavor and aroma to remain in the food. It also minimizes the chemical conversion load needed at the catalytic converter to maintain scent neutrality in the commercial foodservice operation due to cooking.

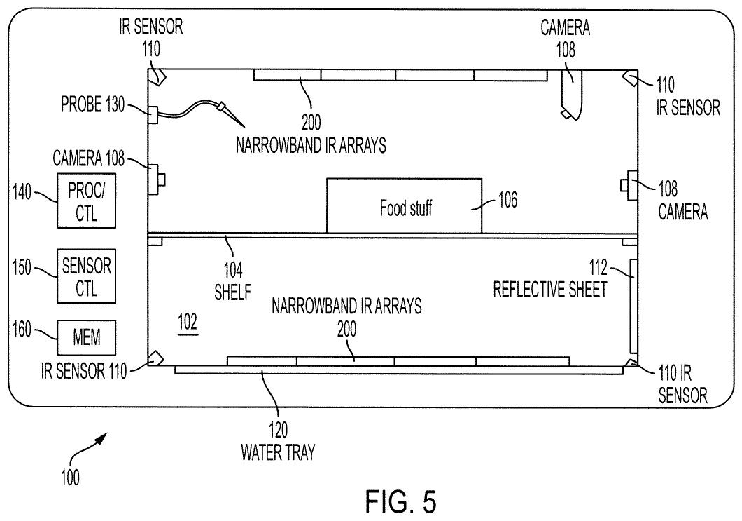

With reference now to FIG. 5, an example system 100 to implement the presently described embodiments is illustrated. The system 100 may take a variety of forms according to the presently described embodiments. In at least one form, the system 100 is an oven, i.e., a narrowband radiating oven, having an oven cavity 102. In the oven cavity 102, a shelf 104 is provided to support any foodstuff 106 that is placed in the oven cavity 102 for thawing, heating and/or cooking. Reflective sheets, an example of which is shown at 112, are provided. Although a single reflective sheet is shown, in practice, several reflective sheets may be strategically positioned in the oven cavity 102 to, for example, reflect radiation back to the target foodstuff 106.

The oven 100 may also be provided with cameras 108. It should be appreciated that the number of cameras and their position may well vary depending on their specific function and capability. The camera(s) 108 could be used to detect a physical property of the comestible or food item. The camera could be an infrared camera to detect, for example, temperature, or a digital, visible light camera to detect visual characteristics. Temperature sensors of various forms may also be used. For example, infrared (IR) sensors 110 are also suitably placed inside the oven cavity. The IR sensor may be calibrated to monitor temperature. A temperature probe 130 is also included in at least one form of the system. Of course, the temperature probe 130 may be used in any suitable manner including for insertion into the food item. Other sensors such as sensors to detect weight of the food item, or sensors to detect airborne chemicals may be used in examples of implementation.

The oven 100 is also provided with appropriate control and processing capability. In one form, the oven 100 includes a processor or controller 140 to control, among other functions and hardware, the narrowband arrays 200 that are strategically implemented in the oven 100, e.g., in the oven cavity 102, to radiate the foodstuff with narrowband energy according to various recipes. The oven 100 is also provided with a sensor control system 150 to control sensors in the system, including the IR sensors 110 and cameras 108. Of course, a memory unit 160, or several memory units, are included in the system. In this regard, the presently described embodiments, in at least one example, include suitable software program(s) (e.g., instructions and/or code which are stored on the at least one memory 160) which, when executed by at least one processor, cause the processor and/or associated elements of the system to implement the method(s) according to the presently described embodiments. The source of the instructions may vary. However, in at least one form, executed cooking instructions use information from at least one of machine learning or artificial intelligence environments.

Also, in at least one example, NREDs having a FWHM wavelength spectrum of less than 80 nm and an output peak wavelength in the 720 nm to 1180 nm range can be further paired with any other broadband heat source. As an example, the broadband heat source comprises at least one of quartz lamps, halogen lamps, heating from chemical reactions such as oxidizing combustibles to create flames, or resistive heating elements. In addition, radio frequency elements or microwave elements could be implemented and selectively activated for defrosting, heating, cooking, boiling, or other form of treating the food item in addition to narrowband surface heating.

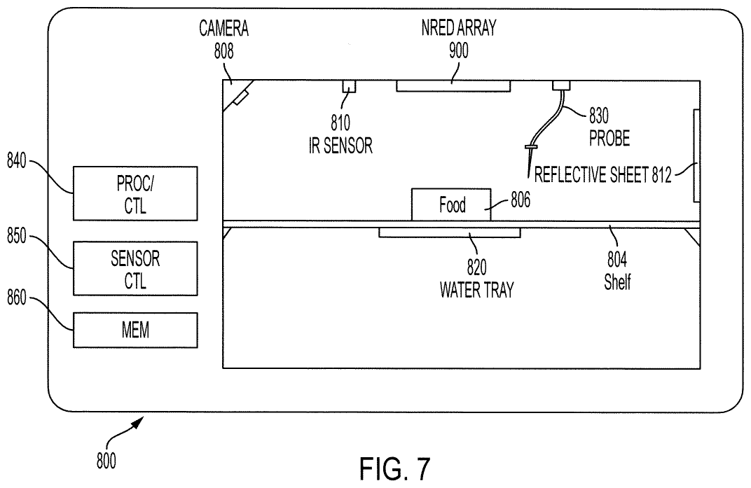

With reference now to FIG. 7, another example system 800 to implement the presently described embodiments is illustrated. The system 800 may take a variety of forms according to the presently described embodiments. In at least one form, the system 800 is a refrigeration unit, i.e., provided with a narrowband radiating thawing unit, having a cavity 802. In the cavity 802, a shelf 804 is provided to support any foodstuff 806 that is placed in the cavity 802 for thawing. Reflective sheets, an example of which is shown at 812, are provided. Although a single reflective sheet is shown, in practice, several reflective sheets may be strategically positioned in the cavity 802 to, for example, reflect radiation back to the foodstuff 806.

The unit 800 may also be provided with cameras 808. It should be appreciated that the number of cameras and their position may well vary depending on their specific function and capability. Infrared (IR) sensors 810 are also suitably placed inside the coven cavity. A temperature probe 830 is also included in at least one form of the system. Of course, the temperature probe 830 may be used in any suitable manner including for insertion into the food item.

The unit 800 is also provided with appropriate control and processing capability. In one form, the unit 800 includes a processor or controller 840 to control, among other functions and hardware, the narrowband arrays 900 that are strategically implemented in the unit 800, e.g., in the cavity 802, to radiate the foodstuff with narrowband energy according to various recipes. The unit 800 is also provided with a sensor control system 850 to control sensors in the system, including the IR sensors 810 and cameras 808. Of course, a memory unit 860, or several memory units, are included in the system. In this regard, the presently described embodiments, in at least one example, include suitable software program(s) (e.g., instructions and/or code which are stored on the at least one memory 860) which, when executed by at least one processor, cause the processor and/or associated elements of the system to implement the method(s) according to the presently described embodiments.

Also, it will be appreciated that the structures and procedures shown above are only a representative example of embodiments that can be used to facilitate embodiments described above. In this regard, the various embodiments described in the examples above may be implemented using any suitable circuitry, hardware, and/or software modules that interact to provide particular results. One of skill in the computing arts can readily implement such described functionality, either at a modular level or as a whole, using knowledge generally known in the art. For example, the methods described herein may be used to create computer-readable instructions/code for execution by a processor. Such instructions may be stored on a non-transitory computer-readable medium and transferred to, for example, the processor for execution as is known in the art.

In this regard, it should be appreciated that the processors and controllers and the sensor controllers are merely examplesthey may take a variety of forms. For example, the above-described methods and/or techniques can be implemented on a system such as an oven, refrigeration unit, or similar device using well-known computer processors, memory units, storage devices, computer software, and other components. As shown in the example representations of such a system, the units include at least one processor, which controls the overall operation of the units by executing computer program instructions which define such operation. The computer program instructions may be stored in at least one storage device or memory (e.g., a magnetic disk or any other suitable non-transitory computer readable medium or memory device) and loaded into another memory (not shown) (e.g., a magnetic disk or any other suitable non-transitory computer readable medium or memory device), or another segment of memory, when execution of the computer program instructions is desired. Thus, the steps of the methods described herein may be defined by the computer program instructions stored in the memory and controlled by the processor (and/or the processer) executing the computer program instructions.

According to various embodiments, FIGS. 5 and 7 are an example representation of possible components of a system including a processor for illustrative purposes. Of course, the system may include other components. Also, the oven or refrigeration unit is illustrated as primarily a single device or system. However, they may be implemented as more than one device or system and, in some forms, may be a modular or distributed system with components or functions suitably distributed in, for example, a network or in various locations.

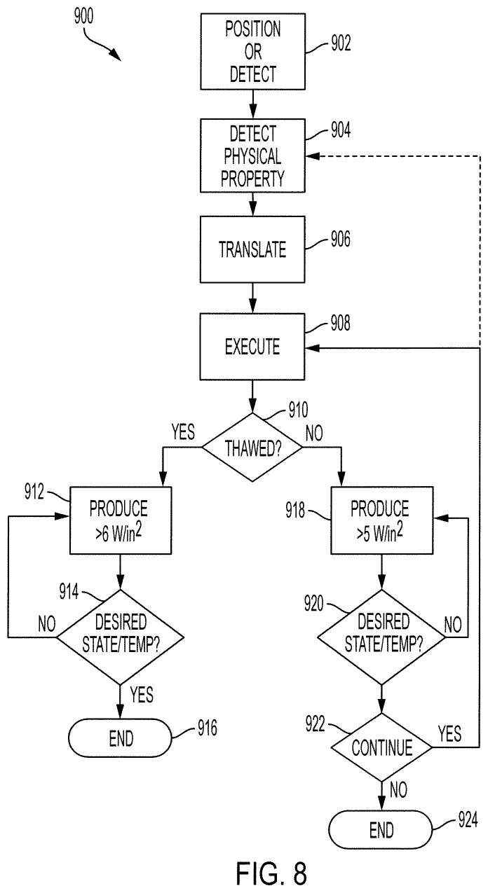

The system (e.g., such as systems shown in FIGS. 5 and 7) according to the presently described embodiments may implement a variety of methods according to the presently described embodiments. For example, with reference to FIG. 8, the system 100 or a variation thereof may perform a method to thaw and/or heat a food item that is at least partially frozen. As shown, an example method 900 is initiated by positioning or detecting the food item in an irradiation area configured for irradiation of the food item by at least one array of narrowband infrared radiation emitting devices (NREDs) (at 902). Typically, in this example, the food item has at least three (3) times the absorptive units at a selected peak wavelength as associated water does at the selected peak wavelength. Also, in at least one form, the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking.

The method also includes detecting (at 904), by at least one sensor positioned in the irradiation area and operatively connected to a control system, at least one physical property of at least one of the food item, the irradiation area and an environment during a heating process. The detected physical property is translated into at least one measurement (at 906).

Cooking instructions are executed (at 908) utilizing instructions, such as stored instructions, to bring the food item to a desired state and temperature in accordance with at least one of: the at least one property detected by the at least one sensor positioned in the system or the at least one measurement. In this regard, there is a determination of whether the food item is thawed (at 910) and the executing includes at least producing (at 918), by the at least one array of NREDs, at least 5 Watts per square inch of narrowband infrared energy at a target plane of the food item when the target is in its at least partially frozen state. The irradiation area, in at least one form, is supplied with the at least 5 Watts per square inch of infrared narrowband energy to each of at least 12 square inches of the target plane. The method includes determining if a desired state or temperature is achieved (at 920). If not, the at least 5 Watts per square inch is still supplied to the irradiation area. If the desired state or temperature is achieved, a determination is made (at 922) whether the method continues (e.g., to implement another cooking sequence) or ends (at 924) (e.g., if a successful thaw occurs and no further cooking is required). If the method continues, in at least one form, the execution of the instructions is continued, for example (at 908). Alternatively, the method may continue at detection of a physical property (at 904, or elsewhere).

Referring back to 902, if the food item is in a thawed state, the executing includes producing (at 912), by the at least one array of NREDs, at least 6 Watts per square inch of infrared energy at the target plane. The irradiation area is supplied with the at least 6 Watts per square inch of infrared narrowband energy to the each of the at least 12 square inches of the target plane. The method includes determining if a desired state or temperature is achieved (at 914). If not, the at least 6 Watts per square inch is still supplied to the irradiation area. If the desired state or temperature is achieved, ends (at 916) (e.g., if successful cooking has occurred and no further cooking is required).

It should be appreciated that the method 900 further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

It should also be appreciated that bringing the food item to a desired state and temperature comprises, in at least one form, bringing the food item to a temperature above freezing. In at least one form, it also comprises applying energy to affect at least one of defrosting the food item or temperature rise in the food item.

As a further example, the method further comprises accelerating thawing the food item within a refrigerated area and holding the food item at a maximum temperature of 5° F. above that of the refrigerated area, wherein accelerated thawing is achieved through moving the food item having at least some frozen component into an enclosed irradiation area wherein the atmosphere in the enclosed irradiation area is conditioned to maintain at least a specific range of temperatures, wherein the at least one NREDs are configured to irradiate the food target with at least 5 Watts per square inch of narrowband infrared energy at a target plane of the food item during any portion of the thawing process, monitoring the food item and a rate of change in temperature of the food item as the food item is being irradiated using narrowband infrared radiation, and based on data collected during the irradiation of the food item in at least one of a frozen and thawed state, adjusting at least one of radiation intensity and duration to bring the food item to the desired state and temperature in accordance with the at least one sensor positioned in the system.

In at least one form, for example, the detecting, translating and executing comprises monitoring the food item and a rate of change in temperature of the food item as the food item is being irradiated using narrowband infrared radiation, processing temperature data based on expected heat transfer parameters of various food items, determining a state of the food item by analyzing temperature rise of the food item when exposed to at least one of known irradiation intensity or variation in irradiation intensity, analyzing at least one of sensor output, time, and operator observations while executing a first set of cooking instructions for applying heat energy to the food item in a frozen state until the food item reaches a thawed state, executing a separate set of cooking instructions once the food item reaches an expected thawed state, after being confirmed by sensor data that the food has achieved a thawed state, and based on data collected during irradiation of the food item in at least one of a frozen and a thawed state, adjusting the cooking instructions to bring the food item to the desired state and temperature in accordance with the at least one sensor positioned in the system.

In a further example, the method further comprises monitoring a weight of the food item in an at least one point of time, wherein a point in time being a minimum of is one of before and or during irradiation of the food item using narrowband infrared radiation, processing the weight data based on expected heat transfer parameters of various food items, and analyzing the weight data based on temperature rise and joules of energy injected to calculate a projected temperature rise and, if actual temperature rise varies from projected temperature rise, executing an adjustment to bring the food item to the desired state and temperature in accordance with the at least one sensor positioned in the system.

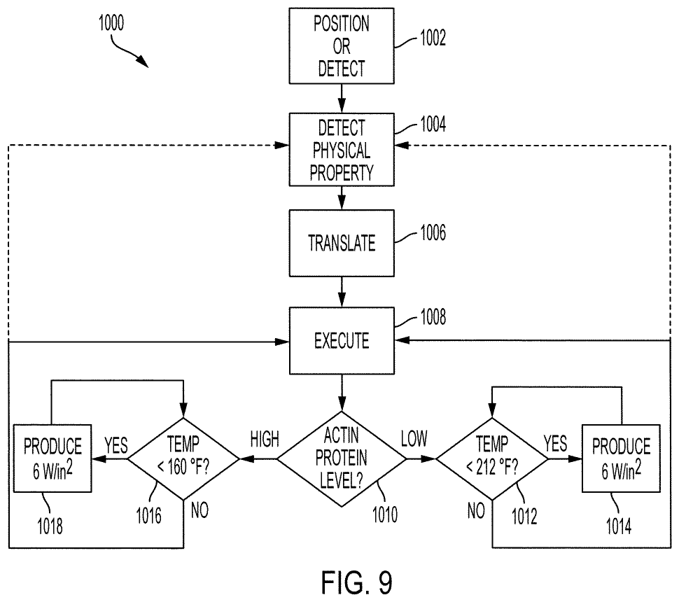

With reference now to FIG. 9, as a further example, the system 1000 or a variation thereof may perform a method for heating a food item to maximize at least one of flavor retention, nutrient retention, moisture retention, and any combination of the three. The example method 1000 comprises positioning or detecting the food item in an irradiation area configured for irradiation of the food item by at least one array of narrowband infrared radiation emitting devices (NREDs) (at 1002). The food item typically has, in this example form, at least three (3) times the absorptive units at a selected peak wavelength as associated water does at the selected peak wavelength. The NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking.

The method 1000 includes detecting (at 1004), by at least one sensor positioned in the irradiation area and operatively connected to a control system, at least one physical property of at least one of the food item, the irradiation area and an environment during a heating process. The detected physical property is translated (at 1006) into at least one measurement.

Cooking instructions are executed (at 1008), in accordance with at least one of: the detecting or the translating, utilizing, for example, stored instructions. In this regard, a determination is made on the Actin protein level in the food item (at 1010). If the Actin protein level is low, a majority of the food item is maintained below a boiling point of water (212° F. (100° C.) at 1 atmosphere of pressure) for the duration of the irradiation of the food item in accordance with the detection by the at least one sensor positioned in the system. The method (e.g., the executing) thus includes determining if the temperature is less the 212° F. (100° C.) at 1 atmosphere of pressure (at 1012). If so, at least 6 Watts per square inch of infrared energy at the target plane when the target is in a thawed state, wherein the irradiation area is supplied the at least 6 Watts per square inch of infrared narrowband energy to each of at least 12 square inches of a target plane (at 1014). If the temperature is not less the 212° F. (100° C.) at 1 atmosphere of pressure, the method continues to execute further instructions (at 1008) or detect (at 1004).

Referring back to 1010, if the Actin protein level is high, the food item is maintained below 155° F. (68° C.) for the duration of the irradiation of the food item in accordance with the detection by the at least one sensor positioned in the system. The method (e.g., the executing) thus includes determining if the temperature is less the 155° F. at 1 atmosphere of pressure (at 1016). If so, at least 6 Watts per square inch of infrared energy at the target plane when the target is in a thawed state, wherein the irradiation area is supplied the at least 6 Watts per square inch of infrared narrowband energy to each of at least 12 square inches of a target plane (at 1018). If the temperature is not less the 155° F. at 1 atmosphere of pressure, the method continues to execute further instructions (at 1008) or detect (at 1004).

The method 1000 also comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

In a further example, the method further comprises detecting air-born chemical samples at least one time in an atmosphere of the irradiation area, processing the air-born chemical sample based on at least one expected physical property of at least one chemical, translating at least one detected physical property of the chemical into measurement values of chemical concentration within the sampled atmosphere, comparing the measurement values to an at least one desired stored value to maintain temperature of the food item below a temperature at which the chemical affecting smell would be released in sufficient quantities to exceed desired values within the irradiation area based on current atmospheric conditions in the irradiation area.

In at least one form, the processing of the air-born chemical sample is based on information from at least one of machine learning algorithms and artificial intelligence.

In at least one form, the air-born chemical sample detected is trimethylamine.

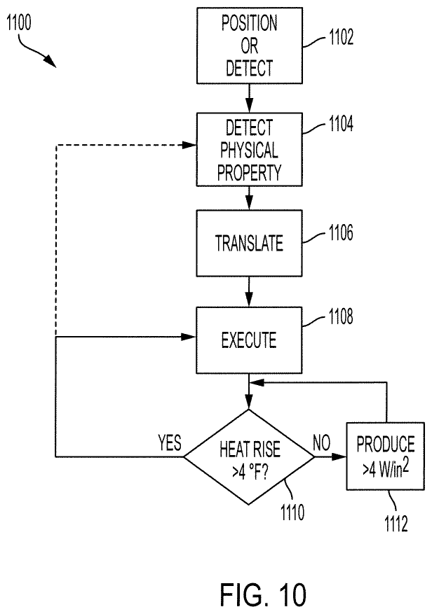

With reference now to FIG. 10, in a further example, the system 100 or a variation thereof may perform a method for heating the surface of food items to maximize flavor, nutrient, and moisture retention. The example method 1100 comprises positioning or detecting the food item in an irradiation area configured for irradiation of the food item by at least one array of narrowband infrared radiation emitting devices (NREDs) (at 1102). The food item has at least five (5) times the absorptive units at a selected peak wavelength within a range of 1380 nm to 1580 nm range as water would have if irradiated using narrowband infrared radiation within a range of 720 nm to 1180 nm range. In at least one form, the NREDs are operative having a Full Width at Half Maximum (FWHM) wavelength spectrum width of less than 80 nanometers (nm) and an output peak wavelength in the 1380 nm to 1580 nm range, to effect at least one of defrosting, heating, and cooking.

The method 1100 includes detecting (at 1104), by at least one sensor positioned in the irradiation area and operatively connected to a control system, at least one physical property of at least one of the food item, the irradiation area and an environment during a heating process. The detected physical property is translated into at least one measurement (at 1106).

Cooking instructions are executed (at 1108), in accordance with at least one of: the detecting or the translating, utilizing, for example, stored instructions, to increase surface temperature of the food item to a temperature in a range of 230° F. (110° C.) to 397° F. (203° C.) while heat generated from application of the narrowband wavelength operative in the range of 1380 nm to 1580 nm does not affect a heat rise in a majority of the food item by more than 5° F. (3° C.) while under irradiation from the at least one array of NREDs operative in the range of 1380 nm to 1580 nm. Thus, a determination is made as to whether the heat rise is greater than 5° F. (3° C.) (at 1110), If not, the method (e.g., the executing) includes at least producing (at 1112), by the at least one array of NREDs, at least 4 Watts per square inch of infrared energy at the target plane when the target is in a thawed state, wherein the irradiation area is supplied the at least 4 Watts per square inch of infrared narrowband energy to each of at least 12 square inches of a target plane. If so, the method continues to execute (at 1108) or detect (at 1104),

It should be appreciated that the method 1100 further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

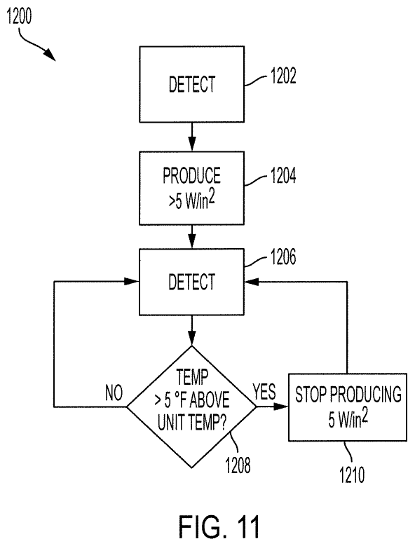

As a still further example, with reference to FIG. 11, the refrigeration unit 800 or variations thereof may perform a method for thawing food items in a refrigerated environment. The example method 1200 comprises detecting a food item in an irradiation area of a refrigeration unit configured for irradiation of the food item by at least one array of narrowband infrared radiation emitting devices (NREDs) (at 1202). The food item, in this example, typically has at least three (3) times the absorptive units at a selected peak wavelength as associated water does at the selected peak wavelength. In at least one form, the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking.

The method includes producing (at 1204), by the at least one array of NREDs, at least 5 Watts per square inch of infrared energy at the target plane when the target is in a frozen or thawed state, wherein the irradiation area is supplied the at least 5 Watts per square inch of infrared narrowband energy to each of at least 12 square inches of a target plane.

The method 1200 further includes detecting (at 1206), by at least one sensor positioned in the irradiation area and operatively connected to a control system, temperature of at least one of the food item, the irradiation area and an environment during a heating process. The food item and a rate of change in the temperature of the food item is monitored as the food item is being irradiated using narrowband infrared radiation to hold the food item at a maximum of 5° F. above that of the refrigeration unit. In this regard, based on data collected during the irradiation of the food item in at least one of a frozen and thawed state, the method includes adjusting at least one of radiation intensity and duration of the producing to bring the food item to the desired state and temperature in accordance with the at least one sensor positioned in the system. At least one example thus includes a determination whether the temperature is greater than a maximum of 5° F. above that of the refrigeration unit (at 1208). If so, the irradiation is ceased. If not, the method 1200 continues with the detecting (at 1206).

Further, it should be appreciated that the method 1200 further comprises continuously controlling or limiting amperes of electrical current supplied to the at least one array of NREDs using a control system operatively connected to at least one Direct Current (DC) power supply, the DC power supply being operatively connected to the at least one array of NREDs, or a power supply which is used in conjunction with at least one electrical component which limits the current to the at least one array of NREDs.

The concepts taught here as to how to implement the presently described embodiments, are intended to help one who wants to configure the presently described embodiments for his specific application and production needs. The examples will show how there are many different ways of implementing the presently described embodiments well beyond the specific examples given. An individual or a team skilled in the respective arts will be able to extend the novel concepts to meet their unique application requirements accordingly.

1. A method to thaw and/or heat a food item that is at least partially frozen, the method comprising:
positioning or detecting the food item in an irradiation area configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
detecting, by at least one sensor positioned in the irradiation area and operatively connected to a control system, at least one physical property of at least one of the food item, the irradiation area or an environment during a heating process;
translating the detected physical property into at least one measurement; and,
executing cooking instructions utilizing instructions to bring the food item to a desired state and temperature in accordance with at least one of: the at least one physical property detected by the at least one sensor positioned in the system or the at least one measurement,
wherein the executing includes at least—
producing, by the at least one array of NREDs, at least 5 Watts per square inch of narrowband infrared energy at a target plane of the food item when the target is in its at least partially frozen state, wherein the irradiation area is supplied with the at least 5 Watts per square inch of infrared narrowband energy to each of at least 12 square inches of the target plane, and
producing, by the at least one array of NREDs, at least 6 Watts per square inch of infrared energy at the target plane when the target is in a thawed state, wherein the irradiation area is supplied with the at least 6 Watts per square inch of infrared narrowband energy to the each of the at least 12 square inches of the target plane,
and wherein the method further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

2. The method as set forth in claim 1, wherein bringing the food item to a desired state and temperature comprises bringing the food item to a temperature above freezing.

3. The method as set forth in claim 1, wherein bringing the food item to a desired state and temperature comprises applying energy to affect at least one of defrosting the food item and temperature rise of the food item.

4. The method as set forth in claim 1, wherein the at least one sensor is a temperature sensor.

5. The method as set forth in claim 1, wherein the at least one sensor is a temperature probe to be inserted in the food item.

6. The method as set forth in claim 1, wherein the at least one sensor is an infrared sensor, calibrated to monitor temperature.

7. The method as set forth in claim 1, wherein the at least one sensor is an infrared camera.

8. The method as set forth in claim 1, wherein the at least one sensor is a digital, visible light, camera.

9. The method as set forth in claim 1, wherein the at least one sensor is used to detect weight of the food item.

10. The method as set forth in claim 1, wherein the at least one sensor is used to detect air-born chemicals.

11. The method as set forth in claim 1, wherein the irradiation area comprises an oven.

12. The method as set forth in claim 1, wherein the instructions comprise stored code.

13. The method as set forth in claim 1, wherein the cooking instructions are executed utilizing information from at least one of machine learning algorithms or artificial intelligence.

14. The method as set forth in claim 1, further comprising:
accelerating thawing the food item within a refrigerated area and holding the food item at a maximum temperature of 5° F. above that of the refrigerated area;
wherein accelerated thawing is achieved through moving the food item having at least some frozen component into an enclosed irradiation area wherein the atmosphere in the enclosed irradiation area is conditioned to maintain at least a specific range of temperatures;
wherein the at least one NREDs are configured to irradiate the food target with at least 5 Watts per square inch of narrowband infrared energy at a target plane of the food item during any portion of the thawing process;
monitoring the food item and a rate of change in temperature of the food item as the food item is being irradiated using narrowband infrared radiation;
based on data collected during the irradiation of the food item in at least one of a frozen and thawed state, adjusting at least one of radiation intensity and duration to bring the food item to the desired state and temperature in accordance with the at least one sensor positioned in the system.

15. The method as set forth in claim 1, wherein the detecting, translating and executing comprises:
monitoring the food item and a rate of change in temperature of the food item as the food item is being irradiated using narrowband infrared radiation;
processing temperature data based on expected heat transfer parameters of various food items;
determining a state of the food item by analyzing temperature rise of the food item when exposed to at least one of known irradiation intensity or variation in irradiation intensity,
analyzing at least one of sensor output, time, and operator observations while executing a first set of cooking instructions for applying heat energy to the food item in a frozen state until the food item reaches a thawed state;
executing a separate set of cooking instructions once the food item reaches an expected thawed state, after being confirmed by sensor data that the food has achieved a thawed state;
based on data collected during irradiation of the food item in at least one of a frozen and a thawed state, adjusting the cooking instructions to bring the food item to the desired state and temperature in accordance with the at least one sensor positioned in the system.

16. The method as set forth in claim 15, further comprising:
monitoring a weight of the food item in an at least one point of time, wherein a point in time is one of before or during irradiation of the food item using narrowband infrared radiation;
processing the weight data based on expected heat transfer parameters of various food items;
analyzing the weight data based on temperature rise and joules of energy injected to calculate a projected temperature rise and, if actual temperature rise varies from projected temperature rise, executing an adjustment to bring the food item to the desired state and temperature in accordance with the at least one sensor positioned in the system.

17. The method as set forth in claim 1, wherein the 12 square inches of target plane are 12 contiguous square inches.

18. A method for heating a food item to maximize at least one of flavor retention, nutrient retention, moisture retention, and any combination of the three, the method comprising:
positioning or detecting the food item in an irradiation area configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
detecting, by at least one sensor positioned in the irradiation area and operatively connected to a control system, at least one physical property of at least one of the food item, the irradiation area or an environment during a heating process;
translating the detected physical property into at least one measurement; and,
executing cooking instructions utilizing stored instructions to maintain a majority of the food item below a boiling point of water (212° F. (100° C.) at 1 atmosphere of pressure) when cooking comestibles low in Actin protein and below 155° F. (68° C.) when cooking food items high in Actin protein for the duration of the irradiation of the food item in accordance with at least one of: the detecting or the translating,
wherein the executing includes at least—
producing, by the at least one array of NREDs, at least 6 Watts per square inch of infrared energy at the target plane when the target is in a thawed state, wherein the irradiation area is supplied the at least 6 Watts per square inch of infrared narrowband energy to each of at least 12 square inches of a target plane,
and wherein the method comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

19. The method as set forth in claim 18, wherein the at least one sensor is a temperature sensor.

20. The method as set forth in claim 18, wherein the at least one sensor is a temperature probe to be inserted in the food item.

21. The method as set forth in claim 18, wherein the at least one sensor is an infrared sensor, calibrated to monitor temperature.

22. The method as set forth in claim 18, wherein the at least one sensor is an infrared camera.

23. The method as set forth in claim 18, wherein the at least one sensor is a digital, visible light, camera.

24. The method as set forth in claim 18, wherein the at least one sensor is used to detect the weight of the comestible or target.

25. The method as set forth in claim 18, wherein the irradiation area comprises an oven.

26. The method as set forth in claim 18, further comprising:
detecting air-born chemical samples at least one time in an atmosphere of the irradiation area;
processing the air-born chemical sample based on at least one expected physical property of at least one chemical;
translating at least one detected physical property of the chemical into measurement values of chemical concentration within the sampled atmosphere;
comparing the measurement values to an at least one desired stored value to maintain temperature of the food item below a temperature at which the chemical affecting smell would be released in sufficient quantities to exceed desired values within the irradiation area based on current atmospheric conditions in the irradiation area.

27. The method as set forth in claim 26, wherein the processing of the air-born chemical sample is based on information from at least one of machine learning algorithms and artificial intelligence.

28. The method as set forth in claim 26, wherein the air-born chemical sample detected is trimethylamine.

29. The method as set out in claim 18, wherein the NREDs having a FWHM wavelength spectrum width of less than 80 nm and an output peak wavelength in the 720 nm to 1180 nm range can be further paired with at least one NRED having a FWHM wavelength spectrum width of less than 80 nm and an output peak wavelength in a range of 1380 nanometers to 1580 nanometers.

30. The method as set out in claim 18, wherein NRED's having a FWHM wavelength spectrum of less than 80 nm and an output peak wavelength in the 720 nm to 1180 nm range can be further paired with any other broadband heat source.

31. The method set forth in claim 30, wherein the broadband heat source comprises at least one of quartz lamps, halogen lamps, heating from chemical reactions such as oxidizing combustibles to create flames, or resistive heating elements.

32. The method as set forth in claim 18, wherein the 12 square inches of target plane are 12 contiguous square inches.

33. A method for heating the surface of food items to maximize flavor, nutrient, and moisture retention, the method comprising:
positioning or detecting the food item in an irradiation area configured for irradiation of the food item by at least one array of narrowband infrared radiation emitting devices (NREDs), wherein the food item has at least five (5) times the absorptive units at a selected peak wavelength within a range of 1380 nm to 1580 nm range as water would have if irradiated using narrowband infrared radiation within a range of 720 nm to 1180 nm range, wherein the NREDs are operative having a Full Width at Half Maximum (FWHM) wavelength spectrum width of less than 80 nanometers (nm) and an output peak wavelength in the 1380 nm to 1580 nm range, to effect at least one of defrosting, heating, and cooking;
detecting, by at least one sensor positioned in the irradiation area and operatively connected to a control system, at least one physical property of at least one of the food item, the irradiation area or an environment during a heating process;
translating the detected physical property into at least one measurement; and,
executing cooking instructions utilizing instructions to increase surface temperature of the food item to a temperature in a range of 230° F. (110° C.) to 397° F. (203° C.) while heat generated from application of the narrowband wavelength operative in the range of 1380 nm to 1580 nm does not affect a heat rise in a majority of the food item by more than 4° F. (2° C.) while under irradiation from the at least one array of NREDs operative in the range of 1380 nm to 1580 nm, in accordance with at least one of: the detecting or the translating,
wherein the executing includes at least—
producing, by the at least one array of NREDs, at least 4 Watts per square inch of infrared energy at the target plane when the target is in a thawed state, wherein the irradiation area is supplied the at least 4 Watts per square inch of infrared narrowband energy to each of at least 12 square inches of a target plane,
and wherein the method further comprises continuously controlling or limiting amperes of electrical current supplied to the at least one array of NREDs using the control system operatively connected to at least one Direct Current (DC) power supply, the DC power supply being operatively connected to the at least one array of NREDs, or a power supply which is used in conjunction with at least one electrical component which limits the current to the at least one array of NREDs.

34. The method as set forth in claim 33, wherein cooking instructions are executed utilizing information from at least one of machine learning algorithms and artificial intelligence.

35. The method as set forth in claim 33, wherein the at least one sensor is a temperature sensor.

36. The method as set forth in claim 33, wherein the at least one sensor is a temperature probe to be inserted in the food item.

37. The method as set forth in claim 33, wherein the at least one sensor is an infrared sensor, calibrated to monitor temperature.

38. The method as set forth in claim 33, wherein the at least one sensor is an infrared camera.

39. The method as set forth in claim 33, wherein the at least one sensor is a digital, visible light, camera.

40. The method as set forth in claim 33, wherein the at least one sensor is used to detect the weight of the comestible or target.

41. The method as set forth in claim 33, wherein the at least one sensor is used to detect air-born chemicals.

42. The method as set forth in claim 33, further comprising executing the cooking instructions to increase surface temperature of the comestible target to a temperature above 397° F. (203° C.) while heat generated from application of the narrowband wavelength operative in the 1380 nm to 1580 nm range does not affect a heat rise in a majority of the comestible target by more than 5° F. (2.8° C.) while under irradiation from the at least one array of NREDs operative in the 1380 nm to 1580 nm range.

43. The method as set forth in claim 33, further comprising radio frequency elements or microwave elements to be selectively activated for defrosting, heating, cooking, boiling, or other form of treating the food item in addition to narrowband surface heating.

44. The method as set forth in claim 33, wherein the 12 square inches of target plane are 12 contiguous square inches.

45. A method for thawing food items in a refrigerated environment, the method comprising:
detecting a food item in an irradiation area of a refrigeration unit configured for irradiation of the food item by at least one array of narrowband infrared radiation emitting devices (NREDs), wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
producing, by the at least one array of NREDs, at least 5 Watts per square inch of infrared energy at the target plane when the target is in a thawed state, wherein the irradiation area is supplied the at least 5 Watts per square inch of infrared narrowband energy to each of at least 12 square inches of a target plane;
detecting, by at least one sensor positioned in the irradiation area and operatively connected to a control system, temperature of at least one of the food item, the irradiation area or an environment during a heating process;
monitoring the food item and a rate of change in the temperature of the food item as the food item is being irradiated using narrowband infrared radiation; and,
based on data collected during the irradiation of the food item in at least one of a frozen and thawed state, adjusting at least one of radiation intensity and duration of the producing to bring the food item to the desired state and temperature in accordance with the at least one sensor positioned in the system,
wherein the food item is held at a maximum of 5° F. above that of the refrigeration unit,
and wherein the method further comprises continuously controlling or limiting amperes of electrical current supplied to the at least one array of NREDs using a control system operatively connected to at least one Direct Current (DC) power supply, the DC power supply being operatively connected to the at least one array of NREDs, or a power supply which is used in conjunction with at least one electrical component which limits the current to the at least one array of NREDs.

46. The method as set forth in claim 45, wherein the 12 square inches of target plane are 12 contiguous square inches.

47. A system to thaw and cook a food item that is at least partially frozen, the system comprising:
at least one array of narrowband infrared radiation emitting devices (NREDs) configured to emit energy in a narrow wavelength band suitable for implementing a thawing process and a cooking process for the food item;
at least one sensor positioned in the system to detect or measure physical properties of at least one of the food item, the system, or environment during the thawing process; and,
at least one processor and at least one memory having stored thereon code or instructions that, when executed by the processor, cause the system at least to:
position or detect the food item in an irradiation area configured for irradiation of the food item by the at least one array of NREDs, wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
detect, by the at least one sensor positioned in the irradiation area and operatively connected to the system, at least one physical property of at least one of the food item, the irradiation area or the environment during a heating process;
translate the detected physical property into at least one measurement; and,
execute cooking instructions utilizing stored instructions to bring the food item to a desired state and temperature in accordance with at least one of: the detecting or the translating,
wherein executing includes at least—
producing, by the at least one array of NREDs, at least 5 Watts per square inch of narrowband infrared energy at a target plane of the food item when the target is in its at least partially frozen state, wherein the irradiation area is supplied the at least 5 Watts per square inch of infrared narrowband energy to each of at least 12 contiguous square inches of the target plane, and
producing, by the at least one array of NREDs, at least 6 Watts per square inch of infrared energy at the target plane when the target is in a thawed state, wherein the irradiation area is supplied the at least 6 Watts per square inch of infrared narrowband energy to the each of the at least 12 square inches of the target plane;
wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs.

48. The system as set forth in claim 47, wherein the 12 square inches of target plane are 12 contiguous square inches.

49. A system to thaw and cook a food item that is at least partially frozen, the system comprising:
at least one array of narrowband infrared radiation emitting devices (NREDs) configured to emit energy in a narrow wavelength band suitable for implementing a thawing process and a cooking process for the food item;
at least one sensor positioned in the system to detect or measure physical properties of at least one of the food item, the system, or environment during the thawing process; and,
at least one processor and at least one memory having stored thereon code or instructions that, when executed by the processor, cause the system at least to:
position or detect the food item in an irradiation area configured for irradiation of the food item by the at least one array of NREDs, wherein the food item has at least three (3) times the absorptive units at a selected peak wavelength as water does at the same wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
detect, by the at least one sensor positioned in the irradiation area and operatively connected to the system, at least one physical property of at least one of the food item, the irradiation area or the environment during a heating process;
translate the detected physical property into at least one measurement; and,
execute cooking instructions utilizing stored instructions to maintain a majority of the food item below a boiling point of water (212° F. (100° C.) at 1 atmosphere of pressure) when cooking comestibles low in Actin protein and below 155° F. (68° C.) when cooking food items high in Actin protein for the duration of the irradiation of the food item in accordance with at least one of: the detecting or the translating,
wherein executing includes at least—
producing, by the at least one array of NREDs, at least 6 Watts per square inch of infrared energy at the target plane when the target is in a thawed state, wherein the irradiation area is supplied the at least 6 Watts per square inch of infrared narrowband energy to each of at least 12 square inches of a target plane,
and wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs.

50. The system as set forth in claim 49, wherein the 12 square inches of target plane are 12 contiguous square inches.

51. A system to thaw and cook a food item that is at least partially frozen, the system comprising:
at least one array of narrowband infrared radiation emitting devices (NREDs) configured to emit energy in a narrow wavelength band suitable for implementing a thawing process and a cooking process for the food item;
at least one sensor positioned in the system to detect or measure physical properties of at least one of the food item, the system, or environment during the thawing process; and,
at least one processor and at least one memory having stored thereon code or instructions that, when executed by the processor, cause the system at least to:
position or detect the food item in an irradiation area configured for irradiation of the food item by the at least one array of NREDs, wherein the food item has at least five (5) times the absorptive units at a selected peak wavelength within a range of 1380 nm to 1580 nm range as associated water would have if irradiated using narrowband infrared radiation within a range of 720 nm to 1180 nm range, wherein the NREDs are operative having a Full Width at Half Maximum (FWHM) wavelength spectrum width of less than 80 nanometers (nm) and an output peak wavelength in the 1380 nm to 1580 nm range, to effect at least one of defrosting, heating, and cooking;
detect, by the at least one sensor positioned in the irradiation area and operatively connected to the system, at least one physical property of at least one of the food item, the irradiation area or the environment during a heating process;
translate the detected physical property into at least one measurement; and,
execute cooking instructions utilizing stored instructions to increase surface temperature of the food item to a temperature in a range of 230° F. (110° C.) to 397° F. (203° C.) while heat generated from application of the narrowband wavelength operative in the range of 1380 nm to 1580 nm does not affect a heat rise in a majority of the food item by more than 4° F. (2° C.) while under irradiation from the at least one array of NREDs operative in the range of 1380 nm to 1580 nm, in accordance with at least one of: the detecting or the translating,
wherein executing includes at least—
producing, by the at least one array of NREDs, at least 4 Watts per square inch of infrared energy at the target plane when the target is in a thawed state, wherein the irradiation area is supplied the at least 4 Watts per square inch of infrared narrowband energy to each of at least 12 square inches of a target plane,
and wherein the system is further caused to continuously control or limit amperes of electrical current supplied to the at least one array of NREDs using a control system operatively connected to at least one Direct Current (DC) power supply, the DC power supply being operatively connected to the at least one array of NREDs, or a power supply which is used in conjunction with at least one electrical component which limits the current to the at least one array of NREDs.

52. The system as set forth in claim 51, wherein the 12 square inches of target plane are 12 contiguous square inches.

53. A system to thaw a food item in a refrigerated environment, the system comprising:
at least one array of narrowband infrared radiation emitting devices (NREDs) configured to emit energy in a narrow wavelength band suitable for implementing a thawing process and a cooking process for the food item;
at least one sensor positioned in the system to detect or measure physical properties of at least one of the food item, the system, or environment during the thawing process; and,
at least one processor and at least one memory having stored thereon code or instructions that, when executed by the processor, cause the system at least to:
detect a food item in an irradiation area of a refrigeration unit configured for irradiation of the food item by the at least one array of NREDs, wherein the food item has at least three (3) times the absorptive units at a selected peak wavelength as associated water does at the selected peak wavelength, wherein the NREDs are operative having a Full Width at Half Maximum (FWHM) wavelength spectrum width of less than 80 nanometers (nm) and an output peak wavelength in the 720 nm to 1180 nm range, to effect at least one of defrosting, heating, and cooking;
produce, by the at least one array of NREDs, at least 5 Watts per square inch of infrared energy at the target plane when the target is in a thawed state, wherein the irradiation area is supplied the at least 5 Watts per square inch of infrared narrowband energy to each of at least 12 square inches of a target plane;
detect, by the at least one sensor positioned in the irradiation area and operatively connected to the system, temperature of at least one of the food item, the irradiation area or an environment during a heating process;
monitor the food item and a rate of change in the temperature of the food item as the food item is being irradiated using narrowband infrared radiation; and,
based on data collected during the irradiation of the food item in at least one of a frozen and thawed state, adjust at least one of radiation intensity and duration of the producing to bring the food item to the desired state and temperature in accordance with the at least one sensor positioned in the system,
wherein the food item is held at a maximum of 5° F. above that of the refrigeration unit,
and wherein the system is further caused to continuously control or limit amperes of electrical current supplied to the at least one array of NREDs using a connected Direct Current (DC) power supply, the DC power supply being operatively connected to the at least one array of NREDs, or a power supply which is used in conjunction with at least one electrical component which limits the current to the at least one array of NREDs

54. The system as set forth in claim 53, wherein the 12 square inches of target plane are 12 contiguous square inches.
